(19) United States
(12) Patent Application Publication
(10) Pub. No.: US 2017/0254781 A1
(43) Pub. Date: Sep. 7, 2017

(54) A METHOD AND A DEVICE FOR ACOUSTIC ESTIMATION OF BUBBLE PROPERTIES

(71) Applicant: Commonwealth Scientific and Industrial Research Organisation, Acton, Australian Capital Territory (AU)

(72) Inventors: Steven Spencer, Acton, Australian Capital Territory (AU); Peter Coghill, Acton, Australian Capital Territory (AU); Wen Zhang, Acton, Australian Capital Territory (AU)

(73) Assignee: Commonwealth Scientific and Industrial Research Organisation, Acton, Australian Capital Territory (AU)

(21) Appl. No.: 15/506,640

(22) PCT Filed: Aug. 27, 2015
(86) PCT No.: PCT/AU2015/050499

§ 371 Date: Feb. 24, 2017

(30) Foreign Application Priority Data
Aug. 27, 2014 (AU) 2014903402
Dec. 22, 2014 (AU) 2014905193

(51) Int. Cl. G01N 29/036; G01N 29/032; G01N 29/024; G01N 29/44; G01N 29/46

(52) U.S. Cl. CPC G01N 29/036; G01N 29/4472; G01N 29/46; G01N 29/024; G01N 29/032; G01N 2291/02433

(57) ABSTRACT

Acoustical methods and an associated device, to estimate one or more properties of bubbles in a liquid like medium are provided. Principally, the acoustical method comprises acoustically exciting one or more bubbles in a liquid like medium to oscillate at a resonant frequency, detecting a first signal emitted from an acoustical source arranged to acoustically excite the one or more bubbles and detecting a second signal produced from the one or more bubble oscillations, deriving at least a first and a second characteristic by performing frequency domain analysis on the detected first and second signals, the first characteristic comprising a frequency interference minimum f₁ₘᵢₙ and the second characteristic comprising a bubble resonance fundamental frequency maximum f₁ₘₐₓ and estimating one or more bubble properties from at least the first and second characteristics. Further provided are acoustical methods to estimate the equilibrium size and location of one or more bubbles in a liquid-like medium.

### CROSS-REFERENCE TO RELATED APPLICATIONS

The present application claims priority from Australian Provisional Patent Application No 2014903402 filed on 27 Aug. 2014, Australian Provisional Patent Application No 2014905193 filed on 22 Dec. 2014, the contents of which are incorporated herein by reference.

### TECHNICAL FIELD

Embodiments relate to an acoustical method and a device to estimate the properties of bubbles in a liquid like medium. Examples of bubble properties include bubble equilibrium size, attached solids mass loading and encapsulating layer dilatational viscosity. Further embodiments relate to acoustical methods to estimate one or more properties of a liquid-like medium, wherein the method utilizes the active acoustic response of a gaseous bubble in the medium.

Background detection of bubbles and/or the estimation of the properties of bubbles in a liquid, a slurry substance, or in fluids or tissues is necessary in a variety of industrial processes and medical fields. For instance in the field of mineral extraction utilising froth flotation, the determination of bubble size and distribution within a liquid or liquid like medium are key determinants in the optimisation of froth flotation performance In such an instance it is critical to generate bubbles of the correct diameter based on the size of the particles of interest to be floated in order to ensure that those particles adhere to the bubbles.

One technique for determining bubble properties in applications utilising froth flotation is the passive sensing of acoustic emissions. Sensors, externally mounted to a tank transmit an acoustic signal through the medium in the tank and the received acoustic waves are monitored by hydrophones mounted on rods positioned into the medium. Statistical analysis techniques are then used to extract information from the received signals. The frequency of the received acoustic waves is indicative of the mass of the bubble and therefore the loading upon it.

Other techniques include optical methods which are used to determine in particular the size of bubbles. One such methodology includes sensing the scattered light intensity emitted from micro-bubbles after irradiation by laser. Other techniques such as the McGill bubble size analyser, capture and analyse images of bubbles in flotation systems. This latter technique has been proven effective for bubble size distributions ranging from approximately 0.5 to 3 mm and the accuracy of the methodology relies on image treatment, the counting method and the use of filters. However, optical techniques are considered at their best when imaging a non-opaque liquid and therefore the technique limited.

Other devices and methodologies employ sampling techniques. One such device is a portable AngloP Bubble Sizer (APBS), in which a sampling tube is attached to the bottom of a sealed viewing chamber which is made of plastic PVC with a single reinforced glass window. Bubbles are led from the sampling tube to the chamber which is sloped to spread the bubbles into a single layer to limit overlap and provide an unambiguous plane of focus. The sample of bubbles is photographed and image analysis software processes the images to derive the bubble size distribution. However bubble analysers and sizers which rely on sampling techniques are prone to the introduction of bias when considering sizing of a population of different sized bubbles. Furthermore, sampling devices are prone to bubble break up and coalescence, either of which may introduce additional errors in size distribution estimation.

A number of active acoustic spectroscopic techniques exist for determination of bubble size distributions. Such techniques include geometric (non-resonant) scattering, fundamental resonance excitation, and dual or combination frequency (imaging geometric and resonance fundamental or subharmonic) excitation. An active acoustic device for the measurement of bubble size distribution that is currently commercially marketed is the Acoustic Bubble Spectrometer (ABS) by Dynaflow Inc. The principle of the ABS is based on the solution of an inverse problem for bubble size population which itself is based on acoustic phase velocity and attenuation. However, it is known that this is an ill-posed inverse problem such that small errors in the measured sound speed or attenuation can result in large errors in the estimated bubble size population distribution.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

An acoustical method to estimate one or more properties of bubbles in a liquid like medium is provided, the acoustical method comprising:
acoustically exciting one or more bubbles in a liquid like medium to oscillate at a resonant frequency;
detecting a first signal emitted from an acoustical source arranged to acoustically excite the one or more bubbles and detecting a second signal produced from the bubble oscillations;
deriving at least a first and a second characteristic by performing frequency domain analysis on the detected first and second signals, the first characteristic comprising a frequency interference minimum f₁ₘᵢₙ and the second characteristic comprising a bubble resonance fundamental frequency maximum f₁ₘₐₓ; and
estimating one or more bubble properties from at least the first and second characteristics.

The method may comprise deriving a third characteristic comprising a second harmonic resonance response frequency f₂ₘₐₓ.

The frequency domain analysis may be performed via a power spectral analysis algorithm, for example through Fast Fourier Transform.

The step of acoustically exciting the one or more formed bubbles to oscillate at a resonant frequency may comprise driving the acoustical source to generate a pulsed signal, a tone burst signal, a chirp signal or a broadband acoustic source signal.

In an embodiment where the bubble property includes the bubble equilibrium radius R₀, and where the bubble is either free or encapsulated, R₀ may be estimated from f₁ₘₐₓ and f₁ₘᵢₙ using the relationship:

$${R}_{0} = \frac{1}{2 π} \sqrt{\frac{1}{{f}_{1 max}^{2}} - \frac{1}{{f}_{1 min}^{2}}} \sqrt{\frac{3 {κp}_{0} + \frac{2 {σ}_{0}}{{R}_{0}} ( 3 κ - 1 ) + \frac{4 {𝒳}_{0}}{{R}_{0}}}{{ρ}_{L} E Θ} ;}$$

$$( {f}_{1 min} > {f}_{1 max} )$$

where Θ is a dimensionless coefficient defined by the relationship: Θ=ζΔ+\sqrt{1+ζ²Δ²}, is a coefficient defined by the:

$$Ϛ = \frac{1 + {λ}^{2}}{1 - {λ}^{2}} ; λ = \frac{{f}_{1 max}}{{f}_{1 min}} ,$$

E is a dimensionless coefficient defined by:

$$E = {R}_{0} ( \frac{1}{r} + \frac{1}{{r}_{SB}} ) ,$$

and Δ is a dimensionless coefficient defined by:

$$Δ = \frac{16 {( μ + \frac{{κ}_{S}}{{R}_{0}} )}^{2}}{{R}_{0}^{2} {ρ}_{L} [ 3 κ {p}_{0} + \frac{2 {σ}_{0}}{{R}_{0}} ( 3 κ - 1 ) + \frac{{4}_{{𝒳}_{0}}}{{R}_{0}} ] E} ,$$

where the gas polytropic index κ, ambient pressure p₀, surface tension at equilibrium bubble radius σₒ, elastic compression modulus χ₀, liquid viscosity μ, liquid density ρ_{L} and encapsulating layer dilatational viscosity κₛ are predetermined, the distance r between the bubble and receiver and distance r_{SB} between the source and bubble are approximated.

In such an embodiment the bubble may be loaded or unloaded.

A further bubble property, the attached solids mass loading Mₛ may be estimated from f₁ₘₐₓ and f₁ₘᵢₙ and R₀ using the relationship:

$${M}_{S} = \frac{{R}_{0}}{δ} [ \frac{3 κ {p}_{0} + \frac{2 {σ}_{0}}{{R}_{0}} ( 3 κ - 1 ) + \frac{{4}_{{𝒳}_{0}}}{{R}_{0}}}{4 {π}^{2} {ρ}_{L} {f}_{1 max}^{2}} - {R}_{0}^{2} + \frac{{R}_{0}^{2}}{2} E ( 1 - Θ ) ] ,$$

Where the solids density coefficient δ is defined

$$δ = \frac{1}{4 π} ( \frac{1}{{ρ}_{L}} - \frac{1}{{ρ}_{S}} )$$

and ρ_{S} is the solid density.

Optionally, in an embodiment where κₛ is not predetermined, the attached solids mass loading Mₛ may be estimated from f₁ₘₐₓ and f₁ₘᵢₙ and R₀ using the relationship:

$${M}_{S} = \frac{{R}_{0}}{δ} [ ( \frac{3 κ {p}_{0} + \frac{2 {σ}_{0}}{{R}_{0}} ( 3 κ - 1 ) + \frac{{4}_{{𝒳}_{0}}}{{R}_{0}}}{4 {π}^{2} {ρ}_{L}} ) ( \frac{\frac{1}{{f}_{1 max}^{2}} + \frac{1}{{f}_{1 min}^{2}}}{2} ) - {R}_{0}^{2} ( 1 - \frac{E}{2} ) ] .$$

A still further bubble property, the encapsulating layer dilatational viscosity κₛ may be estimated from f₁ₘₐₓ and f₁ₘᵢₙ and R₀ using the relationship:

$${κ}_{S} = {R}_{0} \{ \frac{{R}_{0}}{4} \sqrt{( \frac{{Θ}^{2} - 1}{2 {Θ}_{Ϛ}} ) E {ρ}_{L} [ 3 κ {p}_{0} + \frac{2 {σ}_{0}}{{R}_{0}} ( 3 κ - 1 ) + \frac{{4}_{{𝒳}_{0}}}{{R}_{0}} ]} - μ \} ,$$

where the dimensionless coefficient Θ is expressed as:

$$Θ = [ \frac{3 κ {p}_{0} + \frac{2 {σ}_{0}}{{R}_{0}} + \frac{{4}_{{𝒳}_{0}}}{{R}_{0}}}{4 {π}^{2} {ρ}_{L} {ER}_{0}^{2}} ] ( \frac{1}{{f}_{1 max}^{2}} - \frac{1}{{f}_{1 min}^{2}} ) .$$

In an embodiment where the bubble property includes the bubble equilibrium radius R₀, and where the bubble is a clean unloaded bubble, R₀ may be estimated from f₁ₘₐₓ using the relationship:

$${R}_{0} = \frac{1}{2 π {f}_{1 max}} \sqrt{\frac{3 κ {p}_{0} + \frac{2 {σ}_{0}}{{R}_{0}} ( 3 κ - 1 ) + \frac{{4}_{{𝒳}_{0}}}{{R}_{0}}}{{ρ}_{L} [ 1 - \frac{E}{2} ( 1 - Θ ) ]}} ,$$

where Θ is a dimensionless coefficient defined by the relationship: Θ=ζΔ+\sqrt{1+ζ²×²}, is a coefficient defined by the relationship:

$$Ϛ = \frac{1 + {λ}^{2}}{1 - {λ}^{2}} ; λ = \frac{{f}_{1 max}}{{f}_{1 min}} ,$$

E is a dimensionless coefficient defined by the relationship:

$$E = {R}_{0} ( \frac{1}{r} + \frac{1}{{r}_{SB}} ) ,$$

and Δis a dimensionless coefficient defined by the relationship:

$$Δ = \frac{16 {( μ + \frac{{κ}_{S}}{{R}_{0}} )}^{2}}{{R}_{0}^{2} {ρ}_{L} [ 3 κ {p}_{0} + \frac{2 {σ}_{0}}{{R}_{0}} ( 3 κ - 1 ) + \frac{{4}_{{𝒳}_{0}}}{{R}_{0}} ] E} ,$$

and where the gas polytropic index κ, ambient pressure p₀, surface tension at equilibrium bubble radius ρₒ, elastic compression modulus χ₀, liquid viscosity μ, liquid density ρ_{L} and encapsulating layer dilatational viscosity κₛ are predetermined and the distance r between the bubble and receiver and distance r_{SB} between the source and bubble are approximated.

Optionally, in an embodiment where the bubble property includes the bubble equilibrium radius R₀, and where the bubble is a clean unloaded bubble, R₀ may be estimated from f₁ₘₐₓ and f₁ₘᵢₙ using the relationship:

$${R}_{0} = \frac{1}{2 π} \sqrt{\frac{1}{2} ( \frac{1}{{f}_{1 max}^{2}} + \frac{1}{{f}_{1 min}^{2}} )} \sqrt{\frac{3 κ {p}_{0} + \frac{2 {σ}_{0}}{{R}_{0}} ( 3 κ - 1 ) + \frac{{4}_{{𝒳}_{0}}}{{R}_{0}}}{{ρ}_{L} [ 1 - \frac{E}{2} ]}} ,$$

where the gas polytropic index κ, ambient pressure p₀, surface tension σₒ, elastic compression modulus χ₀, and liquid density ρ_{L}, are predetermined and the distance r between the bubble and receiver and distance r_{SB} between the source and bubble are approximated.

Optionally, in the case of a ‘clean’ (unloaded) bubble, the encapsulating layer dilatational viscosity κₛ may be estimated from f₁ₘₐₓ and f₁ₘᵢₙ and known or estimated equilibrium radius R₀ using the relationship:

$${κ}_{S} = {R}_{0} \{ \frac{{R}_{0}}{{4}_{Ϛ}} \sqrt{\frac{{ρ}_{L}}{2} [ 3 κ {p}_{0} + \frac{2 {σ}_{0}}{{R}_{0}} ( 3 κ - 1 ) + \frac{{4}_{{𝒳}_{0}}}{{R}_{0}} ] [ \frac{{( 2 - E )}^{2} - {Ϛ}^{2} {E}^{2}}{2 - E} ]} - μ \} ,$$

where the liquid viscosity μ and density ρ_{L}, gas polytropic index κ and bubble surface tension parameters are predetermined, and r and r_{SB} are approximated.

In an embodiment where the bubble property includes the bubble equilibrium radius R₀, and where the bubble is a free (unencapsulated) bubble and negligible liquid viscosity effects on the bubble characteristics, R₀ may be estimated from f₁ₘₐₓ and f₁ₘᵢₙ using the relationship:

$${R}_{0} = \frac{1}{2 π} \sqrt{\frac{1}{{f}_{1 max}^{2}} - \frac{1}{{f}_{1 min}^{2}}} \sqrt{\frac{3 κ {p}_{0} + \frac{2 {σ}_{0}}{{R}_{0}} ( 3 κ - 1 )}{{ρ}_{L} E}} ; ( {f}_{min} > {f}_{max} ) ,$$

where the gas polytropic index κ, ambient pressure p₀, surface tension σ^{o}, and liquid density ρ_{L} are predetermined and r and r_{SB} are approximated.

In the case of nil attached solids, for a free bubble and negligible liquid viscosity effects on the bubble characteristics, the bubble equilibrium radius R₀ may be estimated from f₁ₘₐₓ and f₁ₘᵢₙ via the relationship:

$$\begin{matrix}{R}_{0} = \frac{1}{2 π {f}_{1 max}} \sqrt{\frac{3 κ {p}_{0} + \frac{2 {σ}_{0}}{{R}_{0}} ( 3 κ - 1 )}{{ρ}_{L}}} & \\ or & \\ {R}_{0} = \frac{1}{2 π {f}_{1 min}} \sqrt{\frac{3 κ {p}_{0} + \frac{2 {σ}_{0}}{{R}_{0}} ( 3 κ - 1 )}{{ρ}_{L} ( 1 - E )}} , & \end{matrix}$$

where

$$E = 1 - {( \frac{{f}_{1 max}}{{f}_{1 min}} )}^{2}$$

in this case, and where the gas polytropic index κ, ambient pressure p₀, surface tension σₒ, and density ρ_{L} are predetermined.

A further bubble property, the attached solids mass loading Mₛ may be estimated in the case of a free bubble and negligible liquid viscosity effects on the bubble characteristics using the relationship:

$${M}_{S} = \frac{{R}_{0}}{δ} ( \frac{3 κ {p}_{0} + \frac{2 {σ}_{0}}{{R}_{0}} ( 3 κ - 1 )}{4 {π}^{2} {ρ}_{L} {f}_{1 max}^{2}} - {R}_{0}^{2} ) ,$$

where

$$δ = \frac{1}{4 π} ( \frac{1}{{ρ}_{L}} - \frac{1}{{ρ}_{S}} )$$

and where ρₛ, the density of a single solid particle attached to the bubble surface is predetermined.

Optionally, the attached solids mass loading Mₛ may be estimated using the relationship:

$${M}_{S} = {R}_{0} \frac{[ 3 κ {p}_{0} + \frac{2 {σ}_{0}}{{R}_{0}} ( 3 κ - 1 ) ]}{4 {π}^{2} {ρ}_{L} δ} [ \frac{1}{{f}_{1 max}^{2}} - \frac{1}{E} ( \frac{1}{{f}_{1 max}^{2}} - \frac{1}{{f}_{1 min}^{2}} ) ] ,$$

where

$$δ = \frac{1}{4 π} ( \frac{1}{{ρ}_{L}} - \frac{1}{{ρ}_{S}} )$$

and where ρₛ, the density of a single solid particle attached to the bubble surface is predetermined.

In a further embodiment, the attached solids mass loading Mₛ of a free or encapsulated bubble may be estimated from the second harmonic peak frequency f₂ₘₐₓ, and R₀ using the relationship:

$${M}_{S} \approx \frac{{R}_{0}}{δ} ( \frac{3 κ {p}_{0} + \frac{2 {σ}_{0}}{{R}_{0}} ( 3 κ - 1 ) + \frac{4 {χ}_{0}}{{R}_{0}}}{{π}^{2} {ρ}_{L} {f}_{2 max}^{2}} - {R}_{0}^{2} )$$

where

$$δ = \frac{1}{4 π} ( \frac{1}{{ρ}_{L}} - \frac{1}{{ρ}_{s}} ) ,$$

and where the gas polytropic index κ, ambient pressure p₀, surface tension σₒ, elastic compression modulus χ₀, ρₛ and density ρ_{L} are predetermined.

In this embodiment the equilibrium bubble radius R₀ is estimated from the three characteristics: f₁ₘₐₓ, f₁ₘᵢₙ and f₂ₘₐₓ (frequencies of fundamental resonance maximum, interference minimum and second harmonic maximum, respectively) by the expression

$${R}_{0} \approx \frac{1}{2 π} \sqrt{2 [ \frac{4}{{f}_{2 max}^{2}} - \frac{1}{2} ( \frac{1}{{f}_{1 max}^{2}} + \frac{1}{{f}_{1 min}^{2}} ) ]} \sqrt{\frac{3 κ {p}_{0} + \frac{2 {σ}_{0}}{{R}_{0}} ( 3 κ - 1 ) + \frac{4 {χ}_{0}}{{R}_{0}}}{{ρ}_{L} E}} ,$$

where the gas polytropic index κ, ambient pressure p₀, surface tension σₒ, elastic compression modulus χ₀, and density ρ_{L} are predetermined and r and r_{SB} are approximated. The dilatational viscosity of any encapsulating layer may be estimated by the expression

$${κ}_{S} = {R}_{0} \{ \frac{{R}_{0}}{4} \sqrt{( \frac{{Θ}^{2} - 1}{2 Θς} ) E {ρ}_{L} [ 3 κ {p}_{0} + \frac{2 {σ}_{0}}{{R}_{0}} ( 3 κ - 1 ) + \frac{4 {χ}_{0}}{{R}_{0}} ]} - μ \} ,$$

where the dimensionless coefficient Θ is estimated from

$$Θ = [ \frac{3 κ {p}_{0} + \frac{2 {σ}_{0}}{{R}_{0}} + \frac{4 {χ}_{0}}{{R}_{0}}}{4 {π}^{2} {ρ}_{L} {ER}_{0}^{2}} ] ( \frac{1}{{f}_{1 max}^{2}} - \frac{1}{{f}_{1 min}^{2}} )$$

and the coefficient ζ is defined by

$$ς = \frac{1 + {λ}^{2}}{1 - {λ}^{2}} ;$$

$$λ = \frac{{f}_{1 max}}{{f}_{1 min}} .$$

This embodiment is applicable in the case where the second harmonic peak frequency f2 max provides additional information (f₂ₘₐₓ·2f₁ₘₐₓ). This is the case for instance for O(1-10) micron equilibrium radius bubbles in water. However, it is not the case for larger bubbles in water.

The method may further comprise effecting movement of the one or more bubbles. Effecting movement may comprise driving the one or more bubbles by liquid flow.

It should be appreciated that the three characteristics of the acoustic power response curve at the receiver; f₁ₘₐₓ, f₁ₘᵢₙ and f₂ₘₐₓ, are a function of the properties of the gas and liquid phases and the monitoring system geometry. Tables 1 to 4 shown below for the three characteristics as a function of bubble equilibrium size and attached solids mass loading in the following cases: (i) Encapsulated microbubble (Definity™ characteristics) in water at atmospheric pressure; (ii) Encapsulated microbubble (Definity™ ultrasound contrast agent characteristics) in full human blood at body temperature and atmospheric pressure; (iii) Free (unencapsulated) macrobubble in water at atmospheric pressure; and (iv) Free (unencapsulated) macrobubble in Brent crude oil at atmospheric pressure.

Table 1 shows that the f₁ₘₐₓ characteristic decreases over the range ˜1.54×10⁴ to 3.6×10² kHz as equilibrium bubble radius increases over the range 0.5-10 μm for a Definity™ microbubble in water at atmospheric pressure. At any given equilibrium bubble size the f₁ₘₐₓ characteristic decreases with increasing solids mass loading. For example ˜6.55×10³to 6.35×10³ kHz as attached solids mass loading increases over the range 0-10 pg for a 1 μm equilibrium bubble radius.

TABLE 1
Frequencies (kHz) of the f_{1max,} f₁ₘᵢₙ and f₂ₘₐₓ characteristics of the
acoustic response as a function of equilibrium radius R_0 (μm) and
attached solids (lipid/polymer layer) mass loading M_S (picograms) to
forced oscillation of an encapsulated microbubble (Definity ™ charac-
teristics) in water at atmospheric pressure (r = 1e−4 m., r_{SB} = 1e−4 m.).
Consecutive rows are shown for each of the f_{1max,} f₁ₘᵢₙ and f₂ₘₐₓ
characteristics at each level of attached solids mass loading. Entries
marked NA are in violation of the thin attached layer approximation.

| | R_0 (micron) | | | |
|---|---|---|---|---|
| M_S (pg) | 0.5 | 1 | 5 | 10 |
| 0 | 1.5356E+04 | 6.5512E+03 | 8.2947E+02 | 3.5752E+02 |
| | 3.8297E+04 | 8.7860E+03 | 8.8787E+02 | 4.0053E+02 |
| | 4.0213E+04 | 1.4780E+04 | 1.6710E+03 | 7.1568E+02 |
| 0.1 | 1.5321E+04 | 6.5490E+03 | 8.2946E+02 | 3.5752E+02 |
| | 3.8042E+04 | 8.7822E+03 | 8.8787E+02 | 4.0053E+02 |
| | 4.0097E+04 | 1.4755E+04 | 1.6709E+03 | 7.1568E+02 |
| 1 | 1.5016E+04 | 6.5300E+03 | 8.2944E+02 | 3.5752E+02 |
| | 3.5945E+04 | 8.7477E+03 | 8.8784E+02 | 4.0053E+02 |
| | 3.9097E+04 | 1.4727E+04 | 1.6709E+03 | 7.1568E+02 |
| 10 | NA | 6.3487E+03 | 8.2923E+02 | 3.5751E+02 |
| | NA | 8.4234E+03 | 8.8759E+02 | 4.0052E+02 |
| | NA | 1.4273E+04 | 1.6705E+03 | 7.1566E+02 |
| 100 | NA | NA | 8.2708E+02 | 3.5739E+02 |
| | NA | NA | 8.8502E+02 | 4.0035E+02 |
| | NA | NA | 1.6661E+03 | 7.1543E+02 |
| 1000 | NA | NA | 8.0648E+02 | 3.5623E+02 |
| | NA | NA | 8.6056E+02 | 3.9874E+02 |
| | NA | NA | 1.6246E+03 | 7.1311E+02 |

TABLE 2
Frequencies (kHz) of the f_{1max,} f₁ₘᵢₙ and f₂ₘₐₓ characteristics of the
acoustic response as a function of equilibrium radius (μm) and attached
solids (lipid/polymer layer) mass loading M_S (picograms) to forced
oscillation of an encapsulated microbubble (Definity ™ characteristics)
in full human blood at body temperature and atmospheric pressure
(r = 1e−4 m., r_{SB} = 1e−4 m.). Consecutive rows are shown for
each of the f_{1max,} f₁ₘᵢₙ and f₂ₘₐₓ characteristics at each level of
attached solids mass loading. Entries marked NA are in violation
of the thin attached layer approximation.

| | R_0 (micron) | | | |
|---|---|---|---|---|
| M_S (pg) | 0.75 | 1 | 5 | 10 |
| 0 | 8.2333E+03 | 5.7615E+03 | 7.7243E+02 | 3.4166E+02 |
| | 1.8733E+04 | 1.0063E+04 | 8.8322E+02 | 3.8963E+02 |
| | 2.1239E+04 | 1.4071E+04 | 1.6029E+03 | 6.8929E+02 |
| 0.1 | 8.2312E+03 | 5.7609E+03 | 7.7243E+02 | 3.4166E+02 |
| | 1.8721E+04 | 1.0061E+04 | 8.8322E+02 | 3.8963E+02 |
| | 2.1232E+04 | 1.4069E+04 | 1.6029E+03 | 6.8929E+02 |
| 1 | 8.2120E+03 | 5.7549E+03 | 7.7242E+02 | 3.4166E+02 |
| | 1.8609E+09 | 1.0043E+04 | 8.8321E+02 | 3.8963E+02 |
| | 2.1171E+04 | 1.4052E+04 | 1.6029E+03 | 6.8929E+02 |
| 10 | NA | 5.6966E+03 | 7.7235E+02 | 3.4165E+02 |
| | NA | 9.8594E+03 | 8.8311E+02 | 3.8962E+02 |
| | NA | 1.3883E+04 | 1.6027E+03 | 6.8929E+02 |
| 100 | NA | NA | 7.7161E+02 | 3.4161E+02 |
| | NA | NA | 8.8212E+02 | 3.8956E+02 |
| | NA | NA | 1.6012E+03 | 6.8920E+02 |
| 1000 | NA | NA | 7.6429E+02 | 3.4119E+02 |
| | NA | NA | 8.7237E+02 | 3.8896E+02 |
| | NA | NA | 1.5857E+03 | 6.8836E+02 |

Table 2 shows that the f₁ₘₐₓ characteristic decreases over the range ˜8.23×10³ to 3.4×10² kHz as equilibrium bubble radius increases over the range 0.75 to10 μm for a Definity™ microbubble in full human blood at body temperature and atmospheric pressure. At any given equilibrium bubble size the f₁ₘₐₓ characteristic decreases with increasing solids mass loading. For example ˜5.76×10³to 5.7×10³ kHz as attached solids mass loading increases over the range 0-10 pg for a 1 μm equilibrium bubble radius.

TABLE 3
Frequencies (kHz) of the f₁ₘₐₓ, f₁ₘᵢₙ and f₂ₘₐₓ characteristics of the acoustic
response as a function of equilibrium radius (mm) and attached solids (glass ballotini)
mass loading (mg) to forced oscillation of a free (unencapsulated) macrobubble in water
at atmospheric pressure (r = 1e−2 m., r_{SB} = 1e−2 m.). Consecutive rows are shown for
each of the f₁ₘₐₓ, f₁ₘᵢₙ and f₂ₘₐₓ characteristics at each level of attached solids mass
loading. Entries marked ‘NA’ are in violation of the thin attached layer approximation.
The entry marked ‘Inf’ denotes the transition of the position of the interference
minimum response frequency f₁ₘᵢₙ towards infinite value as the equilibrium radius of an
unloaded bubble approaches 5 mm.

| | R_0 (mm) | | | | | |
|---|---|---|---|---|---|---|
| M_S (mg) | 0.05 | 0.1 | 0.5 | 1 | 2.5 | 5 |
| 0 | 6.6329E+01 | 3.3003E+01 | 6.5728E+00 | 3.2846E+00 | 1.3134E+00 | 6.5664E−01 |
| | 6.6734E+01 | 3.3343E+01 | 6.9283E+00 | 3.6723E+00 | 1.8575E+00 | Inf |
| | 1.3273E+02 | 6.6011E+00 | 1.3146E+01 | 6.5692E+00 | 2.6268E+00 | 1.3133E+00 |
| 0.001 | 5.7146E+01 | 3.2310E+01 | 6.5716E+00 | 3.2845E+00 | 1.3134E+00 | 6.5664E−01 |
| | 5.7419E+01 | 3.2629E+01 | 6.9270E+00 | 3.6722E+00 | 1.8575E+00 | 1.1153E+03 |
| | 1.1435E+02 | 6.4624E+01 | 1.3143E+01 | 6.5691E+00 | 2.6268E+00 | 1.3133E+00 |
| 0.01 | NA | 2.7560E+01 | 6.5614E+00 | 3.2839E+00 | 1.3134E+00 | 6.5664E−01 |
| | NA | 2.7758E+01 | 6.9150E+00 | 3.6713E+00 | 1.8574E+00 | 3.5241E+02 |
| | NA | 5.5123E+01 | 1.3123E+01 | 6.5678E+00 | 2.6268E+00 | 1.3133E+00 |
| 0.1 | NA | NA | 6.4616E+00 | 3.2775E+00 | 1.3132E+00 | 6.5663E−01 |
| | NA | NA | 6.7984E+00 | 3.6624E+00 | 1.8569E+00 | 1.1143E+02 |
| | NA | NA | 1.2923E+01 | 6.5550E+00 | 2.6265E+00 | 1.3133E+00 |
| 1 | NA | NA | 5.6627E+00 | 3.2156E+00 | 1.3116E+00 | 6.5652E−01 |
| | NA | NA | 5.8854E+00 | 3.5766E+00 | 1.8523E+00 | 3.5238E+01 |
| | NA | NA | 1.1325E+01 | 6.4311E+00 | 2.6232E+00 | 1.3131E+00 |
| 10 | NA | NA | NA | 2.7428E+00 | 1.2955E+00 | 6.5550E−01 |
| | NA | NA | NA | 2.9568E+00 | 1.8079E+00 | 1.1143E+01 |
| | NA | NA | NA | 5.4857E+00 | 2.5911E+00 | 1.3110E+00 |
| 100 | NA | NA | NA | NA | 1.1619E+00 | 6.4553E−01 |
| | NA | NA | NA | NA | 1.4893E+00 | 3.5238E+00 |
| | NA | NA | NA | NA | 2.3238E+00 | 1.2911E+00 |

Table 3 shows that the f₁ₘₐₓ characteristic decreases over the range ˜66.33 to 0.65 kHz as equilibrium bubble radius increases over the range 0.05 to 5 mm for a free bubble in water at atmospheric pressure. At any given equilibrium bubble size the f₁ₘₐₓ characteristic decreases with increasing solids mass loading. For example ˜3.28 to 2.74 kHz as attached solids mass loading increases over the range 0-10 mg for a 1 mm equilibrium bubble radius.

TABLE 4
Frequencies (kHz) of the f₁ₘₐₓ, f₁ₘᵢₙ and f₂ₘₐₓ characteristics of the acoustic
response as a function of equilibrium radius (mm) and attached solids (glass ballotini)
mass loading (mg) to forced oscillation of a free (unencapsulated) macrobubble in
Brent crude oil at atmospheric pressure (r = 1e−2 m., r_{SB} = 1e−2 m.). Consecutive
rows are shown for each of the f₁ₘₐₓ, f₁ₘᵢₙ and f₂ₘₐₓ characteristics at each level of
attached solids mass loading. Entries marked ‘NA’ are in violation of the thin
attached layer approximation. The entry marked ‘Inf’ denotes the transition of the
position of the interference minimum response frequency f₁ₘᵢₙ towards infinite value
as the equilibrium radius of an unloaded bubble approaches 5 mm.

| | R_0 (mm) | | | | | |
|---|---|---|---|---|---|---|
| M_S (mg) | 0.05 | 0.1 | 0.5 | 1 | 2.5 | 5 |
| 0 | 6.8913E+01 | 3.4604E+01 | 6.9264E+00 | 3.4626E+00 | 1.3849E+00 | 6.9241E−01 |
| | 7.0486E+01 | 3.5126E+01 | 7.3014E+00 | 3.8713E+00 | 1.9585E+00 | Inf |
| | 1.3902E+02 | 6.9375E+01 | 1.3853E+01 | 6.9252E+00 | 2.7697E+00 | 1.3848E+00 |
| 0.001 | 5.6849E+01 | 3.3625E+01 | 6.9247E+00 | 3.4625E+00 | 1.3849E+00 | 6.9241E−01 |
| | 5.7906E+01 | 3.4111E+01 | 7.2995E+00 | 3.8712E+00 | 1.9585E+00 | 1.0336E+03 |
| | 1.1455E+02 | 6.7411E+01 | 1.3850E+01 | 6.9250E+00 | 2.7697E+00 | 1.3848E+00 |
| 0.01 | NA | 2.7437E+01 | 6.9101E+00 | 3.4615E+00 | 1.3848E+00 | 6.9241E−01 |
| | NA | 2.7734E+01 | 7.2823E+00 | 3.8699E+00 | 1.9584E+00 | 3.1917E+02 |
| | NA | 5.4995E+01 | 1.3820E+01 | 6.9231E+00 | 2.7697E+00 | 1.3848E+00 |
| 0.1 | NA | NA | 6.7681E+00 | 3.4524E+00 | 1.3846E+00 | 6.9239E−01 |
| | NA | NA | 7.1168E+00 | 3.8571E+00 | 1.9578E+00 | 1.0070E+02 |
| | NA | NA | 1.3537E+01 | 6.9048E+00 | 2.7692E+00 | 1.3848E+00 |
| 1 | NA | NA | 5.7069E+00 | 3.3645E+00 | 1.3823E+00 | 6.9224E−01 |
| | NA | NA | 5.9113E+00 | 3.7357E+00 | 1.9511E+00 | 3.1836E+01 |
| | NA | NA | 1.1414E+01 | 6.7291E+00 | 2.7645E+00 | 1.3845E+00 |
| 10 | NA | NA | NA | 2.7449E+00 | 1.3594E+00 | 6.9078E−01 |
| | NA | NA | NA | 2.9356E+00 | 1.8883E+00 | 1.0067E+01 |
| | NA | NA | NA | 5.4898E+00 | 2.7188E+00 | 1.3815E+00 |
| 100 | NA | NA | NA | NA | 1.1795E+00 | 6.7659E−01 |
| | NA | NA | NA | NA | 1.4776E+00 | 3.1835E+00 |
| | NA | NA | NA | NA | 2.3591E+00 | 1.3532E+00 |

Table 4 shows that the f₁ₘₐₓ characteristic decreases over the range ˜68.91 to 0.68 kHz as equilibrium bubble radius increases over the range 0.05 to 5 mm for a free bubble in Brent crude oil at atmospheric pressure. At any given equilibrium bubble size the f₁ₘₐₓ characteristic decreases with increasing solids mass loading. For example ˜3.46 to 2.74 kHz as attached solids mass loading increases over the range 0 to 10 mg for a 1 mm equilibrium bubble radius.

A device to estimate one or more properties of bubbles in a liquid or liquid like medium is provided, the device comprising:
a chamber or vessel to contain or enable passage of a liquid or liquid like medium, the liquid or liquid like medium supporting one or more bubbles;
at least one acoustic source configured to acoustically excite the one or more bubbles to oscillate at a resonant frequency;
at least one broadband acoustic detector to detect a first signal emitted from the acoustic source and to detect a second signal produced from the bubble oscillations; and
control means to (i) derive at least a first and a second characteristic by performing frequency domain analysis on the detected first and second signals, the first characteristic comprising a frequency interference minimum fₘᵢₙ and the second characteristic comprising a bubble resonance fundamental frequency maximum f₁ₘₐₓ; and (ii) estimate one or more bubble properties from at least the first and second characteristics.

The control means may further derive a third characteristic comprising a second harmonic resonance response frequency f₂ₘₐₓ.

The control means may be operable to perform frequency domain analysis on the detected first and second signals, or the first, second and third signals in order to determine the first f₁ₘᵢₙ and second characteristic f₁ₘₐₓ or first f₁ₘᵢₙ, second f₁ₘₐₓ, and third characteristics f₂ₘₐₓ

In one embodiment, the device comprises a plurality of acoustic sources configured to operate coherently in an array.

The or each acoustic source may be one of an acoustic transducer having performance characteristics suitable for sufficient acoustic excitation of the bubble to be measured. It is necessary that the transducer provide sufficient acoustic power at the bubble location to generate mild acoustic excitation that is detectable by a suitable acoustic receiver. Preferably, the source acoustic power is distributed across the range of fundamental resonance excitation frequencies and source-bubble response interference minimum frequencies (f₁ₘₐₓ and f₁ₘᵢₙ characteristics) that are associated with mild acoustic excitation of bubbles of likely equilibrium sizes, attached solids mass loading and encapsulating layer properties for the system under analysis.

It should be appreciated that mild acoustic excitation occurs when a bubble is excited into stable oscillation at both the fundamental response frequency and coupled higher harmonics. This excludes the situation of unstable or transient cavitation at higher levels of excitation. In the case of a stable response the behaviour of the bubble wall can be expressed in terms of oscillatory functions with frequencies and amplitudes to be determined by the resonance analysis. In mathematical terms, mild acoustic excitation occurs under the following two conditions:

The perturbation parameter used in the analysis is small compared to unity (ξ<<1). This can be used to write a limiting inequality on the amplitude η of the acoustic forcing of bubble relative to the ambient background pressure as

$$η ≪ 1 + \frac{2 {σ}_{0}}{{p}_{0} {R}_{0}} ,$$

where σₒ is the surface tension at equilibrium bubble radius Rₒ and pₒ, is the ambient local pressure. In the case of water at one atmosphere, this leads to η<<1 for a free bubble with equilibrium radius R₀=1e −3 m. (˜101.3 kPa excitation pressure amplitude at the bubble wall) and η<<2.4 (˜243 kPa excitation pressure amplitude at the bubble wall) for an encapsulated bubble with Definity™ characteristics and equilibrium radius R₀=1e−3m.

The scaled peak amplitude response xₘₐₓ of the bubble wall oscillation is assumed to be small compared to unity (xₘₐₓ<<1) in order to ensure small fractional oscillations of the bubble wall under resonant excitation. The adoption of the characteristic value for the mass loading nonlinearity factor relevant to the equilibrium bubble size in the analysis of the bubble oscillatory dynamics suggests the bubble wall fractional oscillation response inequality |xₘₐₓ|≦0.25. The peak amplitude of the bubble wall response at the fundamental frequency of bubble oscillation of the loaded bubble (xₘₐₓ=ξ_{0,max}) can be used to estimate the limiting upper value on the amplitude η of the acoustic forcing of a bubble relative to the ambient background pressure in order to satisfy the bubble wall fractional oscillation response inequality. This limiting upper value can be written as follows:

$$η \leq 0.5 ( 1 + \frac{2 {σ}_{0}}{{p}_{0} {R}_{0}} ) ( {b}_{p} + {c}_{p} ) \sqrt{{ω}_{p}^{2} - {( {b}_{p} + {c}_{p} )}^{2}} ,$$

where the scaled angular eigenfrequency Ωₚ of the oscillating bubble, liquid damping term bₚ and encapsulating layer damping term cₚ are defined by:

$${ω}_{p}^{2} = 3 κ - \frac{2 {σ}_{0}}{{P}_{0} {R}_{0}} + \frac{4 {χ}_{0}}{{P}_{0} {R}_{0}} ;$$

$${b}_{p} = \frac{2 μ}{{{R}_{0} ( {ρ}_{L} {P}_{0} {Γ}_{p}^{*} )}^{1 / 2}} ;$$

$${c}_{p} = \frac{2 {κ}_{S}}{{{R}_{0}^{2} ( {ρ}_{L} {P}_{0} {Γ}_{p}^{*} )}^{1 / 2}}$$

For example, in the case of water at one atmosphere, this leads to η≦2e−4 for a free bubble with equilibrium radius R₀=1e−3 m. (˜20 Pa excitation pressure amplitude at the bubble wall) and η≦1.6 for an encapsulated bubble with Definity™ characteristics and equilibrium radius R₀=1e−6 m. (˜160 kPa excitation pressure amplitude at the bubble wall). It should be appreciated that at larger bubble sizes this is a considerably more restrictive limitation on the maximum allowable amplitude of acoustic stimulation at the bubble location. However, it should further be appreciated that the criterion is based on the maximum bubble wall acoustic amplitude response which occurs at the exact resonant excitation frequency. For millimetre sized bubbles the quality factor of the resonant response is high and hence high amplitude bubble wall oscillations only occur over a small range of frequencies. In practice, acoustic power will be delivered by a source over a wider range of frequencies around the excitation frequency and hence the condition will be more relaxed. Also, the characteristic frequencies are independent of source strength and hence even when the mass loading non-linearity factor is varying significantly over a bubble oscillation, the fundamental frequency of bubble acoustic response will remain unchanged.

As a first example, in the case of encapsulated (Definity™ characteristics) microbubbles in shallow water with equilibrium sizes over the range R₀=0.5-10 μm and attached solids mass loading over the range Mₛ=0-1000 pg, the range of acoustic excitation frequencies would need to be approximately 0.3-50 MHz (see Table 1). In the case of free air bubbles in shallow water in the equilibrium size range R0=0.05−2.5 mm and attached solids mass loading in the range MS=0−100 mg, the range of acoustic excitation frequencies would need to be ˜1-70 kHz (see Table 3). With increasing gas voidage consistent with a higher density of bubbles, a higher power transducer may be necessary (for a fixed distance between source and detector) in order to generate sufficient transmitted acoustic power to be detectable by the receiver.

It is necessary that the acoustic detector be broadband with characteristics such that it has a flat response over a range of frequencies consistent with at least the range of f₁ₘₐₓ, and f₁ₘᵢₙ characteristics that could be generated by the system under analysis with the given range of insonation frequencies that are generated by the source. In embodiments where the f₂ₘₐₓ characteristic is also required, the acoustic detector range of response frequencies is approximately the same as the range generated by the source for encapsulated microbubbles and approximately double the range generated by the source for macrobubbles. For example, in the case of encapsulated (Definity™ characteristics) microbubbles in shallow water with equilibrium sizes over the range R₀=0.5-10 μm and attached solids mass loading over the range M_{S}=0-1000 pg, the range of acoustic detector response frequencies would need to be ˜0.3 - 50 MHz. In the case of free air bubbles in shallow water in the equilibrium size range R0=0.05-2.5 mm and attached solids mass loading in the range MS=0-100 mg, the range of acoustic detector response frequencies would need to be ˜1-140 kHz (see Table 3).

Suitable intrusive and non-intrusive acoustic and ultrasonic sensors are commercially available with flat frequency responses suitable for spectroscopic analysis over all these ranges of response frequencies. In the case of intrusive measurements of macrobubble characteristics, hydrophones with characteristics similar to the Bruel & Kjaer type 8103-8106 range or the Benthowave BII-7000 series could be appropriate according to the details of the application. In the case of intrusive measurements of encapsulated microbubble characteristics, needle hydrophones with characteristics similar to the Precision Acoustics 40 micron −1.0 mm probes or FORCE Technology miniature ultrasonic hydrophones could be appropriate according to the details of the application. In the case of non-intrusive measurements of macrobubble characteristics, a broadband accelerometer such as the Endevco 7259B-10 could be appropriate for characterising larger bubbles and a higher frequency broadband acoustic emission sensor such as in the Kistler 8152B, Vallen Systeme or Physical Acoustics Corporation ranges could be appropriate for characterising smaller macrobubbles. In the case of non-intrusive measurements of encapsulated microbubble characteristics, an ultrasound sensor based on a broadband high frequency piezoelectric sensor such as in the Ultran range could be appropriate according to the details of the application.

The or each acoustic source may be situated on an interior wall of the chamber or an exterior wall of the chamber or within the body of liquid containing bubbles.

Interior walls of the chamber may comprise one or more layers of an anechoic material.

The device may be a microfluidic device.

It should be noted that any of the various features of the above subject of the application can be combined as suitable and desired.

Advantageously, embodiments of the invention are able to be used on-line in a wide variety of physical locations in-situ with minimal intrusive effects. Embodiments of the invention avoid the use of amplitude or power magnitude information which are prone to the peculiarities of the transducer and receiver system.

The proposed methodology provides for a unique and robust solution for bubble properties based on the acoustic characteristics of feature frequencies that are independent of insonation strength at low to moderate acoustic power. In this context, moderate acoustic power is referred to as generating a mild non-linear response that manifests as steady oscillations at the resonance fundamental and second frequencies but avoiding transient cavitation. Embodiments of the invention avoid problems associated with techniques based on the solution of ill-posed inverse problems for bubble properties, such as those associated with acoustic methods based on phase velocity and attenuation.

Further provided is an acoustical method to estimate one or more properties of a liquid-like medium, the acoustical method comprising:
driving an acoustic source to acoustically excite at least one bubble in a liquid-like medium to oscillate at a resonant frequency;
detecting, in a detector, a first signal emitted from the acoustic source and arranged to acoustically excite the at least one bubble and detecting a second signal produced from the bubble oscillations;
deriving at least a first and a second characteristic by performing frequency domain analysis on the detected first and second signals, the first characteristic comprising a frequency interference minimum f₁ₘᵢₙ, and the second characteristic comprising a bubble resonance fundamental frequency maximum f₁ₘₐₓ; and
estimating one or more properties of the liquid-like medium from at least the first and second characteristics; where the distance from the acoustic source to the detector, and either the distance from the acoustic source to the at least one bubble or the detector to the at least one bubble is predetermined.

In the case of a ‘clean’ bubble (one having nil attached solids), such properties may include medium density (solids volumetric concentration) and viscosity. In the case of an encapsulated microbubble such properties may include surface dilatational viscosity and the liquid viscosity.

The device, as previously described may be used to carry out the methodology. Advantageously, this methodology enables an estimate to be made of the solids mass fraction of the liquid like medium (for example the sand content of a crude oil slurry), based on the response of unloaded bubbles in the medium to active acoustic stimulation.

In a first embodiment, the bubble equilibrium radius R₀ may be estimated using the relationship:

$${R}_{0} = \frac{[ 1 - {( \frac{{f}_{1 max}}{{f}_{1 min}} )}^{2} ]}{[ \frac{1}{r} + \frac{1}{{r}_{SB}} ]} ;$$

where r_{SB} denotes the distance between the acoustic source and the bubble and r denotes the distance from the acoustic source to the detector.

In this embodiment, the density of the liquid-like medium may be estimated using the relationship:

$${ρ}_{L} = \frac{3 κ {p}_{0} + \frac{2 {σ}_{0}}{{R}_{0}} ( 3 κ - 1 )}{4 {π}^{2} {R}_{0}^{2} {f}_{1 max}^{2}} ;$$

where the medium ambient pressure p₀, surface tension at equilibrium bubble radius σₒ, and the gas polytropic index κ are predetermined (assuming nil elastic compression modulus for an unencapsulated bubble).

Further, the solids volumetric fraction, may be estimated using the relationship:

$${φ}_{S} = \frac{{ρ}_{L} - {ρ}_{PL}}{{ρ}_{S} - {ρ}_{PL}} ;$$

where the liquid-like medium between the at least one bubble and the detector is two phase, comprising of solid (particle) and pure liquid phases with densities ρₛ and ρ_{PL} respectively known.

In a second embodiment, the method may further comprise deriving a third characteristic comprising a second harmonic resonance response frequency f₂ₘₐₓ.

In the second embodiment, the bubble equilibrium radius R₀ may be estimated using the relationship:

$${R}_{0} \approx \frac{[ 2 - \frac{{f}_{2 max}^{2}}{4} ( \frac{1}{{f}_{1 max}^{2}} + \frac{1}{{f}_{1 min}^{2}} ) ]}{[ \frac{1}{r} + \frac{1}{{r}_{SB}} ]} .$$

The density of the liquid-like medium ρ_{L}, may be estimated using the relationship:

$${ρ}_{L} \approx \frac{3 κ {p}_{0} + \frac{2 {σ}_{0}}{{R}_{0}} ( 3 κ - 1 ) + \frac{4 {χ}_{0}}{{R}_{0}}}{{π}^{2} {f}_{2 max}^{2} {R}_{0}^{2}} ;$$

where the medium ambient pressure p₀, surface tension at equilibrium bubble radius σₒ, encapsulating layer elastic compression modulus χₒ and the gas polytropic index x are predetermined.

Further, the net viscosity μ may be estimated using the relationship:

$${μ}^{1} = \frac{{R}_{0}}{4 ϛ} \sqrt{\frac{{ρ}_{Sl}}{2} [ 3 κ {p}_{0} + \frac{2 {σ}_{0}}{{R}_{0}} ( 3 κ - 1 ) + \frac{4 {χ}_{0}}{{R}_{0}} ] [ \frac{{( 2 - E )}^{2} - {ϛ}^{2} {E}^{2}}{2 - E} ]} ;$$

where

$$E = 2 - \frac{{f}_{2 max}^{2}}{4} ( \frac{1}{{f}_{1 max}^{2}} + \frac{1}{{f}_{1 min}^{2}} ) ,$$

and the coefficient ζ is defined by:

$$ϖ = \frac{{f}_{1 max}}{{f}_{1 min}} .$$

with

$$ϛ = \frac{1 + {ϖ}^{2}}{1 - {ϖ}^{2}} ;$$

Further provided is an acoustical method to estimate the equilibrium size and location of at least one unloaded bubble in a liquid-like medium, the acoustical method comprising:
acoustically exciting one or more bubbles in a liquid like medium to oscillate at a resonant frequency;
detecting a first signal emitted from an acoustic source and arranged to acoustically excite the one or more bubbles and detecting a second signal produced from the one or more bubble oscillations;
deriving at least a first, a second and a third characteristic by performing frequency domain analysis on the detected first and second signals, the first characteristic comprising a frequency interference minimum f₁ₘᵢₙ, the second characteristic comprising a bubble resonance fundamental frequency maximum f₁ₘₐₓ and the third characteristic comprising a second harmonic resonance response frequency f₂ₘₐₓ;
estimating R₀ from each of the three characteristics based on a priori knowledge of the bubble surface dilatational viscosity (κ_{S}),liquid viscosity (μ) and the density of the liquid-like medium (ρ_{L}); and
estimating the location of the at least one bubble using R₀.

The equilibrium radius R₀ of the bubble may be expressed as follows:

$${R}_{0} \approx {\{ {\frac{4 \sqrt{2} ϛ ( μ + \frac{{κ}_{S}}{{R}_{0}} )}{π {f}_{2 max} {ρ}_{L}} [ \frac{2 - E}{{( 2 - E )}^{2} - {ϛ}^{2} {E}^{2}} ]}^{\frac{1}{2}} \}}^{\frac{1}{2}} ;$$

where

$$E \approx 2 - \frac{{f}_{2 max}^{2}}{4} ( \frac{1}{{f}_{1 max}^{2}} + \frac{1}{{f}_{1 min}^{2}} ) .$$

The location of the bubble may then be estimated according to the relationship:

$$\frac{1}{\frac{1}{r} + \frac{1}{{r}_{SB}}} = \frac{{R}_{0}}{E} .$$

The method may further comprise estimating either the ambient pressure of the liquid-like medium or the bubble gas polytropic index. Knowledge of the bubble gas polytropic index allows the chemical species of an unknown gas inside the bubble to be ascertained.

The ambient pressure of the liquid-like medium (p₀) may be determined from the following expression:

$${p}_{0} \approx \frac{1}{3 κ} [ {π}^{2} {f}_{2 max}^{2} {R}_{0}^{2} {ρ}_{L} - \frac{2 {σ}_{0}}{{R}_{0}} ( 3 κ - 1 ) - \frac{4 {χ}_{0}}{{R}_{0}} ]$$

Alternatively, the bubble gas polytropic index (K)may be determined from the following expression:

$$κ \approx \frac{{π}^{2} {f}_{2 max}^{2} {R}_{0}^{2} {ρ}_{L} - \frac{4 {χ}_{0}}{{R}_{0}} + \frac{2 {σ}_{0}}{{R}_{0}}}{3 ( {p}_{0} + \frac{2 {σ}_{0}}{{R}_{0}} )} .$$

An advantage of this methodology is that the bubble equilibrium radius can be determined independently of the distance from the bubble to the acoustic source or independently of the distance from the bubble to an acoustic receiver.

Still further provided is an acoustical method to estimate the equilibrium size, attached solids mass loading and location of at least one loaded bubble in a liquid-like medium, the acoustical method comprising:
acoustically exciting one or more bubbles in a liquid like medium to oscillate at a resonant frequency;
detecting a first signal emitted from an acoustic source and arranged to acoustically excite the one or more bubbles and detecting a second signal produced from the one or more bubble oscillations;
deriving at least a first, a second and a third characteristic by performing frequency domain analysis on the detected first and second signals, the first characteristic comprising a frequency interference minimum f₁ₘᵢₙ, the second characteristic comprising a bubble resonance fundamental frequency maximum f₁ₘₐₓ, and the third characteristic comprising a second harmonic resonance response frequency f₂ₘₐₓ;
estimating R₀ from each of the three characteristics based on a priori knowledge of the bubble surface dilatational viscosity (κ_{S}), liquid viscosity (μ), bubble surface tension (σ), bubble gas polytropic index (κ) and the ambient pressure of the liquid-like medium (p₀);
estimating the attached solids mass loading Mₛ using R₀ and using R₀ and Mₛ to estimate the location of said one or more bubbles.

The relationship between the equilibrium radius R₀ of a bubble and each of the three characteristics, based on a priori knowledge of certain parameters may be determined using the relationship:

$${R}_{0} \approx \frac{\{ \begin{matrix}{[ 2 {σ}_{0} ( 3 κ - 1 ) + 4 {χ}_{0} ] [ 2 - \frac{{f}_{2 max}^{2}}{4} ( \frac{1}{{f}_{1 max}^{2}} + \frac{1}{{f}_{1 min}^{2}} ) ]}^{\frac{1}{2}} - \\ 4 \sqrt{2} {{κ}_{S} ( \frac{ϛ}{{θ}^{2} - 1} )}^{\frac{1}{2}} π {f}_{2 max}\end{matrix} \}}{\{ 4 \sqrt{2} {μ ( \frac{ϛ}{{θ}^{2} - 1} )}^{\frac{1}{2}} π {f}_{2 max} - 3 κ {{p}_{0} [ 2 - \frac{{f}_{2 max}^{2}}{4} ( \frac{1}{{f}_{1 max}^{2}} + \frac{1}{{f}_{1 min}^{2}} ) ]}^{\frac{1}{2}} \}} ;$$

where

$$θ \approx \frac{{f}_{2 max}^{2}}{4} \frac{( \frac{1}{{f}_{1 max}^{2}} - \frac{1}{{f}_{1 min}^{2}} )}{[ 2 - \frac{{f}_{2 max}^{2}}{4} ( \frac{1}{{f}_{1 max}^{2}} + \frac{1}{{f}_{1 min}^{2}} ) ]} .$$

The bubble surface mass loading (M _{S}) may be estimated from the mass loading factor (Γₚ*) using the relationship:

$${M}_{S} = \frac{{R}_{0}^{3}}{δ} ( {Γ}_{p}^{*} - 1 ) ,$$

where δ is the surface solids density coefficient defined by:

$$δ = \frac{1}{4 π} ( \frac{1}{{ρ}_{L}} - \frac{1}{{ρ}_{S}} ) ,$$

and where

$${Γ}_{p}^{*} \approx \frac{4 \sqrt{2} ( μ + \frac{{κ}_{S}}{{R}_{0}} )}{π {R}_{0}^{2} {ρ}_{L} {f}_{2 max}} \frac{{( \frac{Ϛ}{{θ}^{2} - 1} )}^{\frac{1}{2}}}{{[ 2 - \frac{{f}_{2 max}^{2}}{4} ( \frac{1}{{f}_{1 max}^{2}} + \frac{1}{{f}_{1 min}^{2}} ) ]}^{\frac{1}{2}}} .$$

The location of the bubble may then be estimated according to the relationship:

$$\frac{1}{\frac{1}{r} + \frac{1}{{r}_{SB}}} = \frac{{R}_{0}}{E} ,$$

where the coefficient E in the case of a surface mass loaded bubble is defined by the expression:

$$E \approx {Γ}_{p}^{*} [ 2 - \frac{{f}_{2 max}^{2}}{4} ( \frac{1}{{f}_{1 max}^{2}} + \frac{1}{{f}_{1 min}^{2}} ) ] .$$

An advantage of this methodology is that the bubble equilibrium radius and attached solids mass loading can be determined independently of the distance from the bubble to the acoustic source or independently of the distance from the bubble to an acoustic receiver.

### BRIEF DESCRIPTION OF DRAWINGS

In order that the present invention may be more clearly ascertained, embodiments will now be described, by way of example, with reference to the accompanying drawing, in which:

FIG. 1 is a schematic of the conceptual model for a single gaseous bubble surrounded by an encapsulating elastic layer coated with attached solids in a liquid, subject to active acoustic stimulation by a source and monitoring by a receiver;

FIG. 2 is a graph which illustrates example curves for the mass loading factor as a function of the fractional oscillation radius about the equilibrium bubble size;

FIG. 3 is a graph of the receiver pressure power spectra as a function of receiver frequency near the free bubble fundamental resonance frequency (1 mm equilibrium bubble radius and 0, 1 and 10 mg attached solids mass loading);

FIG. 4 is a graph of the receiver pressure power spectra as a function of receiver frequency near the free bubble second harmonic resonance frequency (1 mm equilibrium bubble radius and 0, 1 and 10 mg attached solids mass loading);

FIG. 5 is a graph of the receiver pressure power spectra as a function of receiver frequency near the encapsulated microbubble fundamental resonance frequency (1 μm equilibrium bubble radius and 0, 10 and 100 pg attached solids mass loading);

FIG. 6 is a graph of the receiver pressure power spectra as a function of receiver frequency near the encapsulated microbubble second harmonic resonance frequency (1 μm equilibrium bubble radius and 0, 10 and 100 pg attached solids mass loading);

FIG. 7 is a contour plot of the frequency of the maximum (near the resonance fundamental frequency) in the acoustic receiver average pressure power spectrum as a function of the equilibrium bubble radius and attached solids mass loading (0.25-2.5 mm equilibrium bubble radius and 0-10 mg attached solids mass loading);

FIG. 8 is a contour plot of the frequency of the minimum (near the resonance fundamental frequency) in the acoustic receiver average pressure power spectrum as a function of the equilibrium bubble radius and attached solids mass loading (0.25-2.5 mm equilibrium bubble radius and 0-10 mg attached solids mass loading);

FIG. 9 is a contour plot of bubble radius as a function of the frequencies of the resonance minimum and maximum received average acoustic power (1.8-5.0 kHz resonance minimum and 1.3-5.0 kHz resonance maximum);

FIG. 10 is a contour plot of bubble attached solids mass loading as a function of the frequencies of the resonance minimum and the difference between the frequencies of the maximum and minimum received average acoustic power (1.3-5.0 kHz resonance maximum and 0.0-0.6 kHz difference between resonance maximum and minimum);

FIG. 11a shows a graph of the power spectrum of the total acoustic response of a bubble (˜0.9 mm equilibrium radius and ˜0.85 mg attached solids) insonated by a sweep acoustic signal;

FIG. 11b shows a graph of the bubble response power spectrum of FIG. 6a, normalized by the background (bubble absent) power spectrum;

FIG. 12 is a graph of a waterfall plot of normalised power spectra of the total acoustic response of a single rising stream of bubbles of similar size insonated by an appropriate repeated burst acoustic signal. Power spectra as a function of frequency and bubble production rate;

FIG. 13 is a graph of the power spectrum of the total acoustic response of a cloud or swarm of rising bubbles of similar size insonated by an appropriate repeated burst acoustic signal.

FIG. 14 illustrates a schematic diagram of an acoustic spectrometer in accordance with one embodiment of the invention;

FIG. 15a schematically illustrates a top view of an acoustic spectrometer in accordance with a further embodiment of the invention;

FIG. 15b schematically illustrates a front elevation section A-A of the acoustic spectrometer shown in FIG. 4A; and

FIG. 16 schematically illustrates a top view of an acoustic spectrometer in accordance with a still further embodiment of the invention.

### DESCRIPTION OF EMBODIMENTS

Embodiments generally relate to methods and apparatus utilising acoustic spectroscopy to measure various properties of bubbles in a liquid.

Throughout this specification, the term ‘free bubble’ refers to cavities filled with air or other gases or gas vapour from a surrounding liquid. Free bubbles have no artificial boundaries to prevent leakage of air or gas from the bubble itself, as a result they tend to be unstable. Free bubbles may float to the top of the liquid and disappear under the influence of gravitation force or may be dissolved into the liquid due to surface tension. A free bubble may be loaded/coated whether partially or fully with solid particles or it may be unloaded/uncoated. In contrast, the term ‘encapsulated bubble’ refers to a bubble with an encapsulating elastic shell which prevents fast gas dissolution and renders the bubble stable. An encapsulated bubble may similarly be loaded/coated with solid particles or it may be unloaded/uncoated. In the case where the encapsulated bubble is coated, the solid particles are typically embedded in the encapsulating elastic material. Technologies responsible for the formation of such encapsulating shells will be appreciated by those skilled the art. The term ‘clean bubble’ refers to a bubble which may be free or encapsulated, but which has no loading.

Embodiments generally operate on the principle that a gas bubble in a liquid, when insonated with acoustic energy from a source, will exhibit a resonant response which varies according to the frequency and magnitude of the insonant acoustic energy, and depends on various properties of the bubble, any encapsulating plastic layer, any solid particle loading and the surrounding liquid medium. The acoustic signal transmitted from the bubble, as well as the source signal, may then be detected by a receiver and analysed to determine certain properties of the insonated bubble. Fourier frequency power spectral analysis may be applied to the received acoustic signal, and peaks may be identified that are associated with the fundamental and second harmonic resonant frequencies of the bubble, and in some embodiments, also with the interference minimum which occurs due to the superposition of the source and bubble acoustic waves at the position of the receiver.

Once the signal analysis has determined the fundamental resonance frequency f₁ₘₐₓ, the interference minimum f₁ₘᵢₙ, and the second harmonic maximum f₂ₘₐₓ, these values can be used to estimate certain properties of the insonated bubble, such as the equilibrium radius R₀, the attached solids mass loading Mₛ, and the encapsulating layer dilatational viscosity Kₛ. Error bounds can be found on the estimates of the various bubble properties by a variety of methods. These include the use of error propagation formulae based on the known analytical solutions for each bubble property and variances of the estimates of each of the dependent variables in the same equations (receiver frequency characteristics, properties of the gas, any encapsulating plastic layer, solid particle loading, surrounding liquid medium and the system geometry). Another approach could be to use Monte Carlo methods to provide error estimates based on injecting random errors into the dependent variables for the various bubble properties. The accuracy of the estimates of the bubble properties can be improved by increasing the frequency resolution and acoustic power sensitivity of the receiver spectral data. Decreasing the distances between the source, bubble(s) and receiver(s) for smaller bubble sizes and increasing the power of the source signal (still maintaining mild acoustic excitation) can also increase the certainty of the bubble parameter estimates. An optimal form of source signal will provide uniform acoustic excitation across the range of frequencies for bubbles in the ranges of equilibrium size, attached solids mass loading and surface layer elasticity expected for the application of interest. The bubble properties can be estimated using the equations derived below from a theoretical model of the acoustic response of an insonated bubble.

Bubble Radius Non-Linear Forced Oscillation Model

Model Formulation

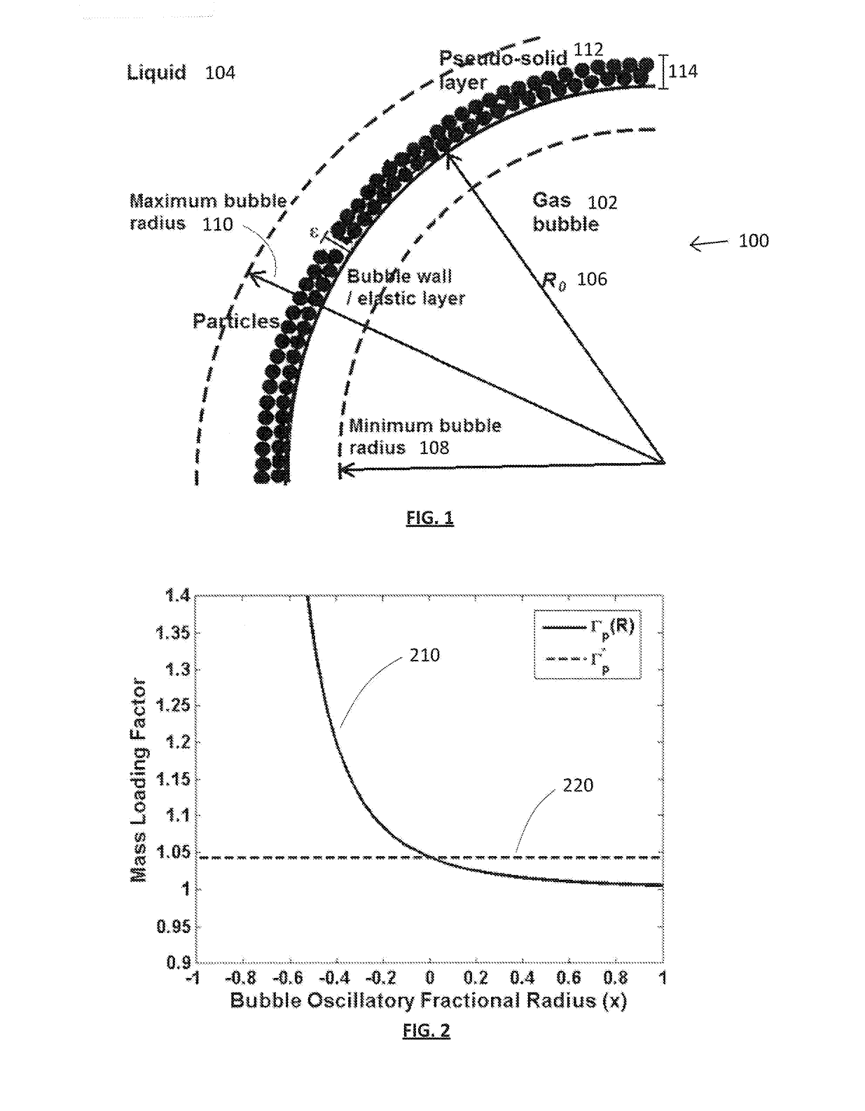

FIG. 1 is a schematic of the conceptual model 100 for a single gaseous encapsulated bubble 102 coated with attached solids in a liquid 104, subject to active acoustic stimulation by a source and monitoring by a receiver (not shown). A solids loaded bubble subject to a low driving sound field at resonance frequency undergoes simple harmonic oscillation about the mean radius R₀ 106, between the minimum bubble radius 108 and the maximum bubble radius 110. The boundary between the bubble gas 102 and surrounding pseudo-solid layer 112 consists of a thin, elastic monolayer shell 114 which encapsulates the bubble; for micron sized bubbles allowing it to persist for an extended period of time. An alternative viewpoint and that illustrated in FIG. 1 is that the pseudo-solid layer itself 112 is composed of solid particles embedded in encapsulating elastic material 114. As should be appreciated, in the case of a free bubble the boundary between the bubble gas and the surrounding pseudo-solid layer is a direct phase interface.

The bubble wall is at radius R(t) at any time (equilibrium radius R₀) and is surrounded by a layer of pseudo-solid of thickness ε(t) and density σₐₜₜ(t) containing solid particles of density σₛ attached to the bubble surface and incompressible liquid of density σ_{L} in the interstices. Some key model assumptions are as follows:

a) Attached solid particle size is significantly smaller than the bubble size.

b) The pseudo-solid layer is significantly smaller than the bubble size.

c) The attached solids are evenly spread over the surface of the bubble.

d) The mass of solids attached to the bubble is assumed to be constant at all times.

e) Outside of the pseudo-solid layer, the incompressible liquid extends to infinite distance.

f) There is a straight line from the acoustic source, through the bubble to the acoustic receiver, such that the acoustic ray path from source to receiver includes that from bubble to receiver. Hence the receiver may detect both the acoustic source and bubble response in transmission.

It should be noted that the effects of gravity and bubble motion relative to the slurry on the shapes of both the bubble and pseudo-solid layer are not considered in this analysis.

A bubble subject to a driving acoustic pressure field behaves as a non-linear oscillator. A modified form of Rayleigh-Plesset equation can be derived for non-linear spherical oscillations of a single bubble in the case of a possible encapsulating elastic shell, an attached mass of solids as particles in a surrounding pseudo-solid layer, and sinusoidal forcing by an acoustic source.

The kinetic energy acquired by liquid surrounding a bubble of equilibrium radius R₀ as it changes to radius R(t) due to an applied pressure field P(t) can be written as follows:

$${φ}_{k} = \frac{1}{2} {\int }_{R}^{R + ɛ} {\dot{r}}^{2} {ρ}_{att} 4 π {r}^{2} dr + \frac{1}{2} {\int }_{R + ɛ}^{∞} {\dot{r}}^{2} {ρ}_{L} 4 π {r}^{2} dr \qquad ( 1 )$$

The thickness of the pseudo-solid layer ε(t) can be written as follows:

$$ɛ = \frac{{M}_{S}}{4 π {ρ}_{S} {R}^{2} {δ}_{S}} \qquad ( 2 )$$

Here δₛ is the attached solids volume fraction and σₐₜₜ is the attached pseudo-solid density. The attached layer and pure solids densities are related by δ_{S}σ_{S}=φ_{S}σₐₜₜ where φₛ is the attached solids mass fraction. They are also subject to the constituent relation σₐₜₜ=σ_{S}δ_{S}+σ_{L}(1−δ_{S}). Both the pseudo-solid and surrounding liquid layers are assumed incompressible. This leads to the following incompressibility condition equating the liquid flow at any radial position exterior to the bubble to the flow at the bubble wall:

$$\frac{\dot{r}}{\dot{R}} = \frac{{R}^{2}}{{r}^{2}} \qquad ( 3 )$$

Introducing Eqns. (2) and (3) into Eqn. (1) leads to the following expression for the kinetic energy of the liquid surrounding the bubble in terms of the radius of the bubble and the thickness of the pseudo-solid layer at any time:

$${φ}_{k} = 2 π {R}^{3} {\dot{R}}^{2} {ρ}_{l} ( \frac{1 + λ ɛ / R}{1 + ɛ / R} ) \qquad ( 4 )$$

Here the ratio of pseudo-solid to liquid density is defined by:

$$λ = \frac{{ρ}_{att}}{{ρ}_{L}} \qquad ( 5 )$$

The assumption of a ‘thin’ pseudo-solid layer at any time (ε/R<<1) then leads to the following expression for the kinetic energy of the liquid surrounding the bubble:

φₖ≈2πR³\dot{R}²σ_{L}Γₚ (6)

Here the mass loading factor Γₚ is defined as:

$${Γ}_{p} = 1 + ( λ - 1 ) \frac{ɛ}{R} \qquad ( 7 )$$

Equation (7) can also be written using Eqn. (5) and the constituent relation between attached pseudo-solid and purse solid densities as:

$${Γ}_{p} = 1 + ( \frac{{ρ}_{S}}{{ρ}_{L}} - 1 ) \frac{{M}_{S}}{4 π {ρ}_{S} {R}^{3}} \qquad ( 8 )$$

The difference between the work done remote from the bubble by the pressure p_{∞}=p₀+P(t) (an applied forcing acoustic pressure P(t) and ambient pressure P₀) and the work done by the pressure p_{L} in the slurry just outside the bubble wall is given by:

$${φ}_{p} = {\int }_{{R}_{0}}^{R} ( {p}_{L} - {p}_{∞} ) 4 π {R}^{2} dR \qquad ( 9 )$$

At any time the kinetic energy acquired by the liquid is equal to the difference in work done during the process.

φₖ=φₚ (10)

Two cases are considered for the effect of the bubble oscillatory radius on the properties of the attached solids loading layer: a) a monolayer of particles spherically symmetrically arranged on the bubble surface; and b) a ‘thin’ multilayer of particles packed on top of each other and spherically symmetrically arranged on the bubble surface.

In the case of (a) the attached solids volume fraction δ_{S} varies as the bubble expands and contracts (δ_{S}∝R⁻²), but the pseudo-solid layer thickness ε=2Rₚ is a constant equal to twice the radius Rₚ of the individual solid particles. This implies that:

$$\frac{\partial ɛ}{\partial R} = 0 \qquad ( 11 )$$

In the base of (b), a ‘thin’ multilayer of particles packed on top of each other and spherically symmetrically arranged on the bubble surface. In this case the pseudo-solid layer thickness ε varies as the bubble expands and contracts but the attached solids volume fraction δₛ is a constant. This case may more closely model the situation of solids particles embedded in an elastic layer. Using Eqn. (2) and the assumption that the mass of the attached solids is a constant leads to the following relationship:

$$\frac{\partial ɛ}{\partial R} = - \frac{2 ɛ}{R} \qquad ( 12 )$$

In both cases however, it can be shown from Eqn. (7) that the dependence of the mass loading factor on the bubble oscillatory radius is the same. This can also be directly established from Eqn. (8), which applies in both cases. The derivative of the mass loading factor with respect to the bubble oscillatory radius can be written in both cases as:

$$\frac{\partial {Γ}_{p}}{\partial R} = - \frac{3}{R} ( {Γ}_{p} - 1 ) \qquad ( 13 )$$

Equations (6) and (9) are substituted into Eqn. (10), which is then differentiated with respect to bubble oscillatory radius. Taking into account Eqn. (13) leads to the following relationship which is valid for both monolayer and ‘thin’ multilayer attached solids loading:

$$\frac{{p}_{L} - {p}_{∞}}{{ρ}_{L}} = {Γ}_{p} R \ddot{R} + \frac{3}{2} {\dot{R}}^{2} \qquad ( 14 )$$

The liquid pressure p_{L}, in the slurry just outside the bubble wall is found from the gas pressure inside the bubble via a boundary condition across the bubble wall interface. Taking into account the gas polytropic index κ, surface tension σ, liquid viscosity ν and the surface dilatational viscosity κₛ of any elastic layer, the liquid pressure just outside the bubble may be written as:

$${p}_{L} = ( {p}_{0} + \frac{2 {σ}_{0}}{{R}_{0}} ) {( \frac{{R}_{0}}{R} )}^{3 κ} - \frac{2 σ ( R )}{R} - \frac{4 μ \dot{R}}{R} - \frac{4 {κ}_{S} \dot{R}}{{R}^{2}} \qquad ( 15 )$$

where σ₀=σ(R₀) is the surface tension at equilibrium bubble radius.

Equation (15) and the expression p_{∞}=p₀=P(t) for the total local pressure (ambient plus acoustic forcing) are substituted into Eqn. (14). The result is the following modified form of Rayleigh-Plesset ordinary differential equation for non-linear spherical oscillations of a single bubble in a viscous liquid, in the case of an encapsulating elastic layer and an outer pseudo-solid attached layer, subject to acoustic excitation:

$${Γ}_{p} ( R ) R \ddot{R} + \frac{3}{2} {\dot{R}}^{2} = \frac{1}{{ρ}_{L}} [ ( {p}_{0} + 2 {σ}_{0} \text{/} {R}_{0} ) {( \frac{{R}_{0}}{R} )}^{3 κ} - \frac{2 σ ( R )}{R} - \frac{4 μ \dot{R}}{R} - \frac{4 {κ}_{S} \dot{R}}{{R}^{2}} - {p}_{0} - P ( t ) ] \qquad ( 16 )$$

Equation (16) in the case of nil attached solids mass loading and nil liquid and elastic layer viscosities reverts to the Rayleigh-Plesset equation, which is well known to be highly non-linear in the case of strong forcing.

The bubble radius dependent surface tension coefficient 6(R) in Eqn. (16) for an elastic layer encapsulated bubble is modelled as being linearly proportional to an elastic compression modulus χ₀ and the difference in bubble radius from the R₀ equilibrium value:

$$σ ( R ) = {σ}_{0} + 2 {χ}_{0} ( \frac{R}{{R}_{0}} - 1 ) \qquad ( 17 )$$

Equation (17) is in accordance with an elastic regime surface tension model for small oscillations of an encapsulated bubble. In the case of a free bubble, Eqn. (17) reverts to a surface tension relevant to the equilibrium bubble size.

A monochromatic sinusoidal pressure forcing term can be written as:

P(t)=−pₒη cos(Ωt) 18)

Here η is the amplitude of the acoustic forcing of the bubble relative to the ambient background pressure at the bubble location, n is the angular frequency of the pressure forcing and t is unscaled time. It should be noted that sinusoidal acoustic excitation is used in this analysis as it is a relatively tractable form of forcing (for perturbation analysis) that assists in demonstrating key results.

Model Solution by Perturbation Method

An approach to the solution of Eqn. (15) that can provide insight into key relationships between acoustic features and bubble physical characteristics for mild acoustic excitation is based on finding approximate analytical solutions for steady oscillations. A linearisation method is here employed to render the modified Rayleigh-Plesset equation tractable for analytical solution in the case of small amplitude excitation, resulting in the separation of the bubble response into fundamental and second harmonic steady oscillatory solutions.

The first step in the linearization procedure is an examination of the dependence of the attached solids mass loading nonlinearity factor Γₚ on the amplitude of bubble oscillations. The radial oscillation of the bubble as a fraction x of the bubble equilibrium radius R₀ is defined by:

R=R₀(1+x) (19)

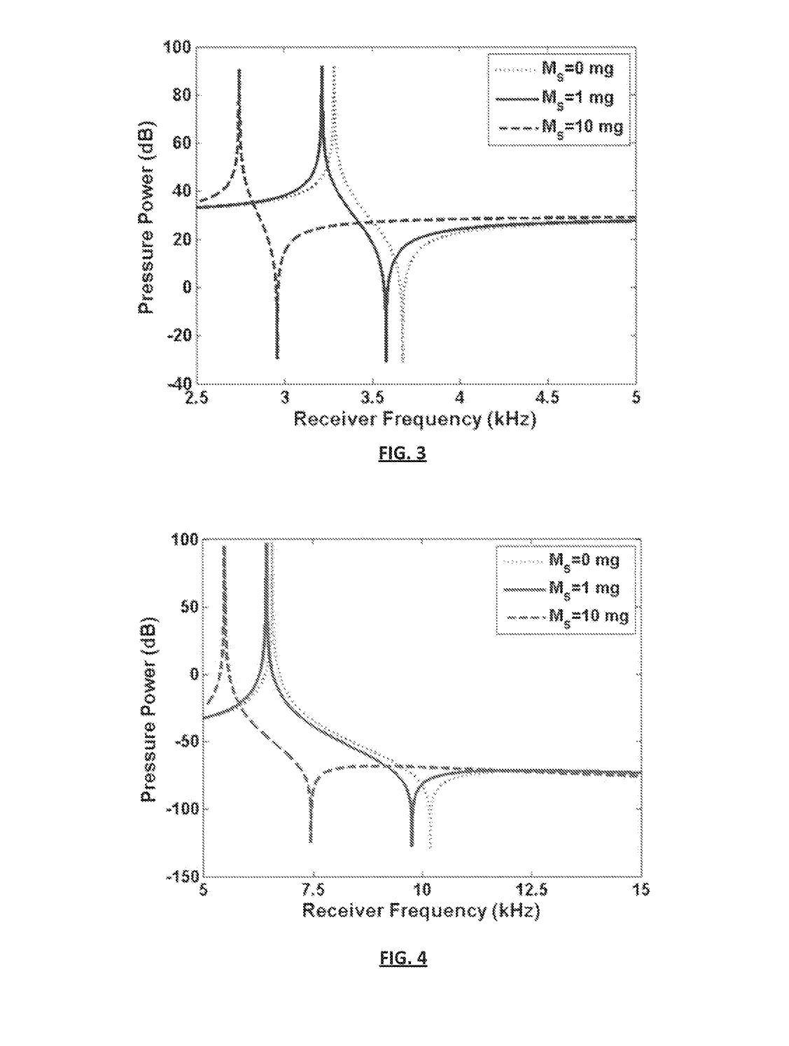

FIG. 2 shows example curves for the mass loading factor Γₚ (dimensionless) as a function of the fractional oscillation radius about the equilibrium bubble size. This example is relevant both for a bubble of size R₀=1 mm loaded with solid particles of mass Mₛ=1 mg or equivalently a microbubble of size R₀=1 μm loaded with solid particles of mass Mₛ=1 pg (see Eqn. (8)). Liquid and solid densities σ_{L}=1000 kg m⁻³ and σₛ=2200 kg m⁻³, respectively. The solid line 210 represents the variation of the mass loading nonlinearity factor (Eqn. (8)) with bubble oscillatory radius. The dotted line 220 is a characteristic (constant) value of the mass loading nonlinearity factor relevant to the equilibrium bubble radius. The characteristic value of the mass loading nonlinearity is only ˜5% larger than the unity value for an unloaded bubble. For large values of the oscillatory fractional radius (x˜1), the nonlinearity factor asymptotes towards unity (see Eqn. (8)). This means that as the bubble expands from its equilibrium size, the attached solids mass has less influence on the oscillatory dynamics of the bubble. On the other hand, as the bubble contracts from its equilibrium size (x<0), the mass loading factor quickly increases. This means that the bubble oscillatory dynamics are asymmetric with respect to the bubble equilibrium radius and are strongly affected by the solids mass loading during the contraction stage for large oscillations. The characteristic value for the mass loading nonlinearity factor relevant to the equilibrium bubble size is here adopted for subsequent analysis of the bubble oscillatory dynamics, with the caveat that this is a reasonable approximation only for small amplitude bubble oscillations (−0.25≦x≦0.25). This seems to be a reasonable first approximation for the mass loading non-linearity term associated with either an I(1 mm) radius bubble loaded with O(1 mg) solids mass or equivalently an O(1 μm) radius bubble loaded with O(1 pg) solids mass, both being situations of potential relevance to this study.

For the case of small amplitude forcing and bubble acoustic response, the modified Rayleigh-Plesset equation describing the non-linear oscillations of a single bubble of radius R in a viscous liquid with an encapsulating elastic layer and an outer pseudo-solid attached layer can be approximated as follows:

$${Γ}_{p}^{*} R \ddot{R} + \frac{3}{2} {\dot{R}}^{2} = \frac{1}{{ρ}_{L}} [ ( {p}_{0} + 2 {σ}_{0} \text{/} {R}_{0} ) {( \frac{{R}_{0}}{R} )}^{3 κ} - \frac{2 σ ( R )}{R} - \frac{4 μ \dot{R}}{R} - \frac{4 {κ}_{S} \dot{R}}{{R}^{2}} - {p}_{0} - P ( t ) ] \qquad ( 20 )$$

Here Γₚ* is the characteristic value of the mass loading nonlinearity factor relevant to the bubble equilibrium radius, as given by Eqn. (8) for Γₚ*=Γₚ(R₀). Again, Eqn. (16) defines the surface tension for elastic oscillations of an encapsulated bubble.

Equation (20) (incorporating Eqns. (17) and (18)) is analytically solved for steady oscillatory motion of the bubble radius using a regular perturbation approach with second order accuracy. The same approach has previously been used to analyse induced non-linear oscillations of unloaded bubbles modelled via the Rayleigh-Plesset equation under a variety of types of low amplitude forcing. The regular perturbation linearisation results in analytical expressions for steady fundamental and second harmonic induced oscillations of the bubble wall.

The perturbation model for small fractional radial oscillations of the bubble wall (x<<1) about its equilibrium radius R₀ is written as:

x=ξ(x₀+ξx₁) (21)

Where x₀ and x₁ are the zeroth and first order perturbation solutions of the fractional radial oscillation amplitude (defined in Eqn. (18)), respectively. Here j is the perturbation parameter (ξ<<1) defined in terms of the acoustic forcing amplitude η as

$$ξ = ( 1 - \frac{2 {σ}_{0}}{{P}_{0} {R}_{0}} ) η \qquad ( 22 )$$

And P₀ is the sum of the ambient gas pressure and the equilibrium surface tension equivalent pressure, as defined by:

$${P}_{0} = {p}_{0} + \frac{2 {σ}_{0}}{{R}_{0}} . \qquad ( 23 )$$

The linear ordinary differential equations derived from perturbation analysis of Eqn. (18) describe the time behaviour of the zeroth and first order perturbation bubble response to acoustic excitation (utilising the definitions in Eqns. (17) and (22)). The resulting coupled pair of forced, damped oscillator equations may be written (to second order accuracy in fractional radial oscillation) as:

$$\begin{matrix} \frac{{d}^{2} {x}_{0}}{d {τ}^{2}} + {ω}_{p}^{2} {x}_{0} + 2 ( {b}_{p} + {c}_{p} ) \frac{{dx}_{0}}{d τ} = cos ( ωτ ) , and & ( 24 ) \\ \frac{{d}^{2} {x}_{1}}{d {τ}^{2}} + {ω}_{p}^{2} {x}_{1} + 2 ( {b}_{p} + {c}_{p} ) \frac{{dx}_{1}}{d τ} = - {x}_{0} cos ( ωτ ) - \frac{3}{2 {Γ}_{p}^{*}} {\dot{x}}_{0}^{2} + α {x}_{0}^{2} + ( 4 {b}_{p} + 6 {c}_{p} ) {x}_{0} {\dot{x}}_{0} & ( 25 )\end{matrix}$$

where the scaled time τ and angular frequency ω, time and angular frequency scaling factor A , scaled angular eigenfrequency ωₚ of the system, liquid and shell viscosity damping terms bₚ and cₚ respectively, are defined as follows:

$$τ = Λ t ; \\ ω = Ω \text{/} Λ ; \\ Λ = {( \frac{{P}_{0}}{{ρ}_{L} {Γ}_{p}^{*}} )}^{1 \text{/} 2} {R}_{0}^{- 1} ; \\ {ω}_{p}^{2} = 3 κ - \frac{2 {σ}_{0}}{{P}_{0} {R}_{0}} + \frac{4 {χ}_{0}}{{P}_{0} {R}_{0}} ; \\ {b}_{p} = \frac{2 μ}{{{R}_{0} ( {ρ}_{L} {P}_{0} {Γ}_{p}^{*} )}^{1 \text{/} 2}} ; \\ {c}_{p} = \frac{2 {κ}_{S}}{{{R}_{0}^{2} ( {ρ}_{L} {P}_{0} {Γ}_{p}^{*} )}^{1 \text{/} 2}} \qquad ( 26 )$$

The time and frequency scalings are defined such that ωτ=Ωt.

The coupling coefficient a linking the amplitude of the second order solution to the square of the amplitude of the first order solution is defined by:

$$α = 9 \text{/} 2 κ ( κ + 1 ) - \frac{4 {σ}_{0}}{{P}_{0} {R}_{0}} + \frac{8 {χ}_{0}}{{P}_{0} {R}_{0}} \qquad ( 27 )$$

The perturbation model oscillatory steady solutions for bubble fractional radius in the case of mild acoustic non-linear excitation of an elastic layer encapsulated, attached solids mass loaded bubble are as follows.

$$O ( ξ ) \text{:} \\ {x}_{0} = C cos ( ωτ + φ ) ; \\ C = \frac{1}{( {ω}_{p}^{2} - {ω}^{2} ) cos φ - 2 ( {b}_{p} + {c}_{p} ) ω sin φ} ; \\ φ = arctan [ \frac{2 ( {b}_{p} + {c}_{p} ) ω}{{ω}^{2} - {ω}_{p}^{2}} ] . \qquad ( 28 )$$

The first order perturbation solution given by Eqn. (28) describes the fundamental resonance response of an encapsulated, solids-loaded bubble to mild acoustic excitation. The amplitude of the solution is a function of the source scaled forcing angular frequency, scaled angular eigenfrequency of the system, and the amplitudes of the liquid and encapsulating shell viscous damping terms. The maximum amplitude C(ω*) of the first order perturbation response of the shell wall at angular frequency ω* is given by C(ω*)=1/[2(bₚ+cₚ)\sqrt{ωₚ²−(bₚ+cₚ)²}], where ω*²=ωₚ²−2(bₚ+cₚ)². O(ξ²):

x₁=A₁cos(2ωπ+φ)+A₂cos(2ωπ+2φ)+A₃. (29)

The second order perturbation solution given by Eqn. (29) describes the second harmonic (non-linear) response of an encapsulated, solids-loaded bubble to mild acoustic excitation. The solution amplitude coefficients A₁(ω, ωₚ,bₚ,cₚ,φ,C), A₂(ω, ωₚ,bₚ,cₚ,φ,C) and A₃(ω, ωₚ,bₚ,cₚ,φ,C) are functions of the source scaled forcing angular frequency, scaled angular eigenfrequency of the system, and the amplitude of the liquid and encapsulating shell viscous damping terms. It can be shown that the scaling factors may be written as follows.

$$\begin{matrix}{A}_{1} = \frac{\begin{matrix}\{ [ - 2 ( {b}_{p} + {c}_{p} ) ω cos φ - 1 \text{/} 2 β sin φ ] C + \\ [ 2 ( {b}_{p} + {c}_{p} ) γ - ( 2 {b}_{p} + 3 {c}_{p} ) β ] ω {C}^{2} \}\end{matrix}}{[ {β}^{2} + {( 4 ( {b}_{p} + {c}_{p} ) ω )}^{2} ] sin φ} , \\ {A}_{2} = \frac{\{ {B}_{1} C + {B}_{2} {C}^{2} sin φ - {B}_{3} {C}^{2} cos φ \}}{[ {β}^{2} + {( 4 ( {b}_{p} + {c}_{p} ) ω )}^{2} ] sin φ} ; & ( 30 ) \\ {B}_{1} = 2 ( {b}_{p} + {c}_{p} ) ω ; \\ {B}_{2} = [ \frac{βγ}{2} + 4 ( {b}_{p} + {c}_{p} ) ( 2 {b}_{p} + 3 {c}_{p} ) {ω}^{2} ] ; \\ {B}_{3} = [ 2 ( {b}_{p} + {c}_{p} ) γ - ( 2 {b}_{p} + 3 {c}_{p} ) β ] ω \\ and \\ & ( 31 ) \\ {A}_{3} = \frac{- C \text{/} 2 cos φ + 1 \text{/} 2 ( α - \frac{3 {ω}^{2}}{2 {Γ}_{p}^{*}} ) {C}^{2}}{{ω}_{p}^{2}} & ( 32 )\end{matrix}$$

Here the coefficients β and γ are defined as:

$$β = {ω}_{p}^{2} - 4 {ω}^{2} ; \\ γ = α + \frac{3 {ω}^{2}}{2 {Γ}_{p}^{*}} \qquad ( 33 )$$

Receiver Pressure Model

The pressure P_{B} radiated by a spherical pulsating bubble in an incompressible liquid can be derived from Euler' s fluid dynamics equations. This leads to the following nonlinear ordinary differential equation:

$${p}_{B} = \frac{{ρ}_{L} R}{r} ( \ddot{R} R + 2 {\dot{R}}^{2} ) - \frac{{ρ}_{L} {\dot{R}}^{2}}{2} {( \frac{R}{r} )}^{4} \qquad ( 34 )$$

Here the variable r is the distance from the bubble to the receiver. It should be noted that as a consequence of the incompressibility assumption in the pressure field modelling, the sound speed in the liquid is infinite and therefore bubble oscillations are communicated instantly through the liquid to the receiver.

In this model both the bubble and the acoustic receiver are aligned in the beam of the excitation source, with the bubble between the source and the receiver. Hence the received signal is a superposition of components due to both the acoustic source and bubble response, detected in transmission. There is a distance r_{SB} between the source and the bubble. Additionally, for a straight line path from the acoustic source through the bubble to the acoustic receiver, the source to bubble and bubble to receiver distances may simply be defined in terms of a fixed distance (rₜₒₜ=r+r_{SB}) between source and receiver.

Introducing the regular perturbation model (Eqn. (21)) for the bubble wall fractional oscillation into Eqn. (34) for the radiated bubble response pressure field leads to the following equation for acoustic pressure due to the bubble at the receiver:

$${P}_{B} = {ρ}_{L} \{ \frac{{R}_{0}^{3}}{r} [ ξ {\ddot{x}}_{0} + {ξ}^{2} ( {\ddot{x}}_{1} + 2 {x}_{0} {\ddot{x}}_{0} + 2 {\dot{x}}_{0}^{2} ) ] - \frac{{ξ}^{2} {R}_{0}^{6} {x}_{0}^{2}}{2 {r}^{4}} \} + O ( {ξ}^{3} ) . \qquad ( 35 )$$

The perturbation solution to Eqn. (35) for the bubble response pressure field can be found by inserting the first and second harmonic solutions (Eqns. (28) and (29)) for the bubble fractional oscillation.

The total (measured) pressure at the receiver is the sum of the bubble (response) and source (imposed) pressure at that point. The total pressure Pₜₒₜ due to the acoustic source and the perturbation model solution for the bubble response fractional oscillation first and second harmonics may be written as follows:

Pₜₒₜ=A+P₁cos(Ωt+φ)+P₂cos(Ωt)+P₃cos(2Ωt+φ)+P₄cos[2(Ωt+φ)]. (36)

It can be shown that the amplitude coefficients of this receiver total pressure solution may be written as follows.

$$\begin{matrix}A = {p}_{0} - \frac{{ρ}_{L}}{4} {( {R}_{0} Λ C ω ξ )}^{2} {( \frac{{R}_{0}}{r} )}^{4} ; \\ {P}_{1} = - {ρ}_{L} ξ {R}_{0}^{2} C {Λ}^{2} {ω}^{2} \frac{{R}_{0}}{r} ; \\ {P}_{2} = - \frac{{p}_{0} η {r}_{SB}}{( {r}_{SB} + r )} ; \\ {P}_{3} = - 4 {A}_{1} {{ρ}_{L} ( {R}_{0} Λ ω ξ )}^{2} \frac{{R}_{0}}{r} ; \\ {P}_{4} = - {{ρ}_{L} ( {R}_{0} Λ ω ξ )}^{2} + \frac{{R}_{0}}{r} [ 4 {A}_{2} + 2 {C}^{2} - \frac{1}{4} {( \frac{{R}_{0}}{r} )}^{3} {C}^{2} ] .\end{matrix} \qquad ( 37 )$$

It should be noted that in this model the pressure amplitude P₂ is due to the acoustic source (which excites the bubble response) but here with a value appropriate to the receiver location. The acoustic source is modelled as a point such that at the bubble location (r=0), the pressure disturbance amplitude is consistent with that used in Eqn. (17) to define the bubble forcing term. This implies that the pressure perturbation due to the excitation source is inversely proportional to the radial distance from the bubble along the line-of-sight to the receiver. Again, the wave speed is modelled as infinite so pressure phase differences due to a finite disturbance travel time between the source, bubble and receiver are not taken into account. The phase difference φ in Eq. (26) is purely due to a lag between the source pressure perturbation at the bubble and the bubble wall response, caused by the liquid viscosity (see Eq. (28)).

Receiver Pressure Average Power Model

The total average power in the pressure field at the receiver may be written as follows in terms of constant background (A²), source excitation frequency (P̅_{ω}²) and double excitation frequency)(P̅_{2ω}²) contributions:

P̅ₜₒₜ²=A²+P̅_{ω}²+P̅_{2ω}². (38)

The average pressure contributions at scaled angular frequencies ω and 2ω can be defined in terms of the amplitude coefficients of the total receiver pressure (Eqn. (37)) and the phase angle φ of the bubble wall oscillation response with respect to the forcing excitation as follows:

$$\begin{matrix}{\overline{P}}_{ω}^{2} = \frac{{P}_{1}^{2}}{2} + \frac{{P}_{2}^{2}}{2} + {P}_{1} {P}_{2} cos φ & ( 39 ) \\ and & \\ {\overline{P}}_{2 ω}^{2} = \frac{{P}_{3}^{2}}{2} + \frac{{P}_{4}^{2}}{2} + {P}_{3} {P}_{4} cos φ . & ( 40 )\end{matrix}$$

Equations (39) and (40) define the total average power in the pressure field at the receiver location in terms of orthogonal components at both the frequency of the excitation source and at double of the same frequency, due to an acoustic point source and the excitation response of a single bubble located between the source and receiver. They include interference effects due to the phase angle between the source pressure oscillations and the bubble response. Equations (39) and (40) can be used to identify the frequencies of the fundamental and second harmonics of the bubble resonance response to acoustic excitation and the frequency of maximum destructive interference between the acoustic source and bubble response average power pressure fields at the receiver location.

Location of Extrema in the Receiver Pressure Average Power as a Function of Frequency. The total average power in the receiver pressure field at the source excitation frequency

Analysis of the total average power in the receiver pressure field at the source excitation frequency (Eqn. (39)) was undertaken to determine the frequency locations of any maxima and minima in the receiver pressure power as a function of source frequency. The frequency of maximum pressure power response is identified with the fundamental of the forced resonance of the acoustically excited bubble. The frequency of minimum pressure power response is identified as the location of maximum destructive interference between the acoustic waves of the active beam and the bubble response as detected at the receiver location. The motivation for this analysis is to provide a solution to the forward problem of predicting the frequencies of the acoustic resonance maximum and interference minimum of a possibly encapsulated, solids-loaded bubble subject to mild acoustic excitation, as a function of bubble gas, liquid, solids and encapsulating elastic layer properties. A comparison between theoretical and experimental estimates of the frequencies of maxima and minima of the received pressure power associated with bubble forced acoustic resonance interference might be used to estimate bubble size and attached solids mass loading. This is a prelude to solution of the inverse problem for estimation of bubble parameters based on forced acoustic resonance interference monitoring features. Another approach that has also been investigated for solving the forward problem was based on finding analytical expressions for the ratio of model amplitudes of the pressure harmonics. However, it has been found that in many situations of interest this can lead to accuracy issues both for the theoretical estimates (violation of the bubble oscillation amplitude constraint implicit in the linearisation of the bubble oscillation equation) and for the experimental estimates (because of the interference between the activation beam and the fundamental resonance bubble response). Accordingly, analysis of the forward problem in this study has concentrated on relating frequency features of the acoustically excited bubble response to bubble characteristics.

Scaled angular frequency values ω* are here found for turning points in the total average power in the receiver pressure field as a function of receiver frequency, at the frequency of bubble acoustic excitation. The scaled angular frequencies of the turning points associated with Eq. (39) are given by ω* that satisfy the following expression:

$$\frac{\partial {P}_{1}}{\partial ω} ( {P}_{1} + {P}_{2} cos φ ) = {P}_{1} {P}_{2} sin φ \frac{\partial φ}{\partial ω} . \qquad ( 41 )$$

Equation (41) is evaluated by introducing the lowest order perturbation model solutions for bubble radius oscillation amplitude C and phase angle φ (Eqn. (28)) and the definitions of the pressure equation coefficients P₁ and P₂ (Eqn. (37)). This leads to a quadratic equation in ω²* which admits two positive solutions corresponding to the receiver frequencies associated with maximum and minimum total average power in the receiver pressure field (at the excitation frequency). This quadratic equation can be written as follows:

y²[ψ(1−2Φ)+P₂(1−4Φ)]−yωₚ²(ψ+2P₂)+P₂ωₚ⁴=0 (42)

Here the variable y and coefficient ψ are defined by:

$$\begin{matrix}y = {ω}_{*}^{2} ; \\ ψ = \frac{{p}_{0} η}{{Γ}_{p}^{*}} \frac{{R}_{0}}{r}\end{matrix} \qquad ( 43 )$$

The coefficient Φ (square of the relative strength of the total encapsulating shell and liquid viscosity damping effects to the scaled angular eigenfrequency of the system) is given by:

$$Φ = \frac{{( {b}_{p} + {c}_{p} )}^{2}}{{ω}_{p}^{2}} \qquad ( 44 )$$

Equation (42) can be solved for the frequency locations of the extrema in the total average power in the receiver pressure field at the excitation frequency in the general case without any assumptions concerning forward model parameter values. This has been done and as expected, there is an exact match between the extrema frequencies predicted by solving Eqn. (42) in its entirety and the observed values of the extrema in the excitation frequency component (and also total) average power of the receiver pressure field computed from Eqn. (39) for all values for forward model parameters. General case solutions of the forward problem for the frequencies of the maximum and minimum of the total average power in the receiver pressure field as a function of relevant bubble, liquid, gas, solid and encapsulating elastic layer properties are given below. These solutions are appropriate for solids-loaded, encapsulated microbubbles used in biomedical applications and also for free, solids-loaded bubbles of all sizes. Solutions are also given for the forward problem in the special case Φ=0, corresponding to negligible liquid and encapsulating layer dilatational viscosities (and also nil elastic layer compression modulus), appropriate for relatively large, free bubbles of interest in many industrial applications.

It should be noted that additional information of value could also be found by undertaking similar analysis aimed at establishing the theoretical frequency locations of any extrema in the receiver pressure power curve at twice the frequency of bubble acoustic excitation.

General Case Solution for Encapsulated and Free Bubbles of all Sizes

The exact solution of Eqn. (42) leads to the following general case equations for the frequencies f*=(f₁ₘₐₓ, f₁ₘᵢₙ) where f*=ω*A/(2π) of the maximum and minimum values for the total average power in the receiver pressure field at the excitation frequency:

$$\begin{matrix}{f}_{1 max}^{2} = [ \frac{3 {κp}_{0} + \frac{2 {σ}_{0}}{{R}_{0}} ( 3 κ - 1 ) + \frac{{4}_{{𝒳}_{0}}}{{R}_{0}}}{4 {π}^{2} {ρ}_{L} {Γ}_{p}^{*} {R}_{0}^{2}} ] \{ \frac{ψ + 2 {P}_{2} + \sqrt{{ψ}^{2} + 8 Φ {P}_{2} ( ψ + 2 {P}_{2} )}}{2 [ ψ + {P}_{2} - 2 Φ ( ψ + 2 {P}_{2} ) ]} \} & ( 45 ) \\ and & \\ {f}_{1 min}^{2} = [ \frac{3 {κp}_{0} + \frac{2 {σ}_{0}}{{R}_{0}} ( 3 κ - 1 ) + \frac{{4}_{{𝒳}_{0}}}{{R}_{0}}}{4 {π}^{2} {ρ}_{L} {Γ}_{p}^{*} {R}_{0}^{2}} ] \{ \frac{ψ + 2 {P}_{2} - \sqrt{{ψ}^{2} + 8 Φ {P}_{2} ( ψ + 2 {P}_{2} )}}{2 [ ψ + {P}_{2} - 2 Φ ( ψ + 2 {P}_{2} ) ]} \} & ( 46 )\end{matrix}$$

Equations (45) and (46) can be used to predict the frequencies of the fundamental resonance maximum and interference minimum total average power in a receiver pressure field for a mildly acoustically excited solids-loaded bubble. This applies for free or encapsulated bubbles of any size.

Specific Case Solution for a Free Bubble and Negligible Liquid Viscosity

The case of the acoustic response of a free or unencapsulated bubble (which may still be loaded with attached solids) for relatively negligible liquid viscosity is of interest in many industrial situations. This occurs if Φ, ψ=0 is substituted in Eqns. (45) and (46). A comparison between the extrema frequencies predicted by such a model ignoring liquid viscosity and those predicted by the general case solution of the full model for total average power in a receiver pressure field suggest that the liquid viscosity can only reasonably be ignored for R₀≧50 μm ᵢn tₕe case of an air bubble in water. This is based on a relative error of less than 10% between the difference in zero liquid viscosity and full model predicted extrema frequencies scaled by the difference between the extrema frequencies themselves.

In the case of negligible liquid viscosity, the free bubble solutions for the frequencies of the maximum and minimum total average power in a receiver pressure field (associated with the fundamental bubble resonance maximum and interference minimum) for a mildly acoustically excited solids-loaded bubble can be written as follows:

$$\begin{matrix}{f}_{1 max}^{2} = \frac{3 {κp}_{0} + \frac{2 {σ}_{0}}{{R}_{0}} ( 3 κ - 1 )}{4 {π}^{2} {ρ}_{L} {Γ}_{p}^{*} {R}_{0}^{2}} & ( 47 ) \\ and & \\ {f}_{1 min}^{2} = \frac{3 {κp}_{0} + \frac{2 {σ}_{0}}{{R}_{0}} ( 3 κ - 1 )}{4 {π}^{2} {ρ}_{L} {Γ}_{p}^{*} {R}_{0}^{2} [ 1 - \frac{E}{{Γ}_{p}^{*}} ]} & ( 48 )\end{matrix}$$

The dimensionless coefficient E is here defined in terms of the distances of the bubble from the source and receiver by:

$$E = {R}_{0} ( \frac{1}{r} + \frac{1}{{r}_{SB}} ) \qquad ( 49 )$$

Provided the total distance from the source to the receiver is a priori known, E is dependent only on the bubble equilibrium radius and one of either the source to bubble or bubble to receiver distances.

Equations (47) and (48) predict the frequencies of maximum and minimum receiver pressure power response due to bubble fundamental resonance excitation, for a bubble at specified distances from both the acoustic source and receiver, as a function of bubble size, attached solids mass loading and surface tension. This is for the case of a free bubble with negligible liquid viscosity, and a straight-line of acoustic transmission from the source, through the bubble to the receiver. Equation (47) is the particulate solids mass loaded analogue of the classical Minnaert relationship between radius and acoustic resonance frequency for a ‘clean’ bubble, extended to include surface tension. It should be noted that if the acoustic source, bubble and receiver are not in a straight line, in principle the separate paths of the active beam and the bubble response beam to the receiver should be taken into account for the accurate estimation of the frequency of the interference minimum However, for the propagation of ˜3 kHz acoustic waves in water (Minnaert resonance frequency for R₀˜1 mm bubbles), the wavelength is ˜0.5 metres. Hence if a receiver is positioned at a distance of ˜1-5 cm from a bubble then the phase differences between the source and response beams due to any acoustic path differences will be reasonably small regardless of where the source is placed with respect to a straight line between the bubble and the receiver. In this situation, Eq. (48) would remain valid regardless of the geometry of the source, bubble and receiver configuration.

Bubble Equilibrium Radius, Attached Solids Mass Loading and Encapsulating Layer Dilatational Viscosity as a Function of the Frequencies of Extrema in the Receiver Pressure Average Power

It is often the case that monitoring is performed in order to estimate some key parameters of a sample under consideration. This process often involves the solution of a model-based inverse problem for parameter estimation based on estimates of acoustic variables derived from the observations. In active acoustic resonance interference monitoring, the frequency positions of the extrema (f₁ₘₐₓ, f₁ₘᵢₙ) in the total average power of the receiver pressure field in a transmission configuration, corresponding to the bubble fundamental resonance maximum and interference minimum, could be estimated from acoustic observations. This is provided that the bubble is stimulated sufficiently so as to induce a steady oscillatory response (but not excessively so as to result in transient cavitation) over a range of frequencies for sufficient time to allow the frequencies of the maximum and minimum receiver power response to be reliably estimated. Where the approximate bubble size is not a priori known, strategies of either pulsed, swept frequency or white noise excitation may be appropriate. The goal would then be to use the observed frequencies of the extrema in received AE power signal as input variables to solve the inverse problem of estimating bubble parameters such as bubble size, attached solids mass loading and encapsulating layer dilatational viscosity.

Closed-form analytical estimators are presented here for the bubble equilibrium radius, attached solids mass loading and encapsulating layer dilatational viscosity in terms of the variables of acoustic resonance fundamental maximum, interference minimum and in some instances the second harmonic maximum frequencies. General case solutions are presented which are valid for arbitrary bubble equilibrium size, liquid and encapsulating layer dilatational viscosity effects. Specific case solutions for bubble equilibrium radius and attached solids mass loading are also presented for large bubbles when total viscosity effects are negligible.

General Case Solutions for Bubble Size, Solids Mass Loading and Encapsulating Layer Dilatational Viscosity

Equations (45) and (46) are combined to provide an estimator for the bubble equilibrium radius (independent of the attached solids mass loading) in the general case of a free or encapsulated bubble of any size. It can be shown that the equilibrium bubble radius in the general case is given by the following expression:

$${R}_{0} = \frac{1}{2 π} \sqrt{\frac{1}{{f}_{1 max}^{2}} - \frac{1}{{f}_{1 min}^{2}}} \sqrt{\frac{3 κ {p}_{0} + \frac{2 {σ}_{0}}{{R}_{0}} ( 3 κ - 1 ) + \frac{{4}_{{𝒳}_{0}}}{{R}_{0}}}{{ρ}_{L} E Θ} ;} ( {f}_{1 min} > {f}_{1 max} ) \qquad ( 50 )$$

The dimensionless coefficient Θ in the denominator is defined by:

Θ=ζΔ+\sqrt{1+ζ²Δ²} (55)

The coefficient ζ is defined as follows, purely as a function of the frequencies of the resonance maximum and interference minimum of the total average power as a function of receiver frequency:

$$\begin{matrix}Ϛ = \frac{1 + {\overline{ω}}^{2}}{1 - {\overline{ω}}^{2}} ; \\ \overline{ω} = \frac{{f}_{1 max}}{{f}_{1 min}}\end{matrix} \qquad ( 52 )$$

The dimensionless coefficient Δ is defined as follows, being finite only for either non-zero liquid viscosity or encapsulating layer dilatational viscosity:

$$Δ = \frac{16 {( μ + \frac{{κ}_{S}}{{R}_{0}} )}^{2}}{{R}_{0}^{2} {ρ}_{L} [ 3 {κp}_{0} + \frac{2 {σ}_{0}}{{R}_{0}} ( 3 κ - 1 ) + \frac{{4}_{{𝒳}_{0}}}{{R}_{0}} ] E} \qquad ( 53 )$$

The estimator for equilibrium bubble radius given by Eqns. (50)-(53) is dependent on knowledge of relevant gas, liquid and encapsulating layer properties (including dilatational viscosity), plus the frequencies of the fundamental resonance maximum and interference minimum of the total average power at the receiver. It should be noted that Eqn. (50) does not require a priori knowledge of the attached solids mass loading. The equation holds both in cases where attached solids and an encapsulating layer are present or absent.

The attached solids mass loading can be found from the following expression (for a given R₀ estimated from Eqns. (50)-(53)):

$${M}_{S} = \frac{{R}_{0}}{δ} [ \frac{3 {κp}_{0} + \frac{2 {σ}_{0}}{{R}_{0}} ( 3 κ - 1 ) + \frac{{4}_{{𝒳}_{0}}}{{R}_{0}}}{4 {π}^{2} {ρ}_{L} {f}_{1 max}^{2}} - {R}_{0}^{2} + \frac{{R}_{0}^{2}}{2} E ( 1 - Θ ) ] \qquad ( 54 )$$

where the solids density coefficient δ is defined by the following expression:

$$δ = \frac{1}{4 π} ( \frac{1}{{ρ}_{L}} - \frac{1}{{ρ}_{S}} ) \qquad ( 55 )$$

Equation (54) is explicitly dependent on the Θ(μ, κ_{S}) parameter and hence a known value for the encapsulating layer dilatational viscosity. An alternative expression for the attached solids mass loading which is not explicitly dependent on the values for the liquid and layer dilatational viscosities is:

$${M}_{S} = \frac{{R}_{0}}{δ} [ ( \frac{3 {κp}_{0} + \frac{2 {σ}_{0}}{{R}_{0}} ( 3 κ - 1 ) + \frac{{4}_{{𝒳}_{0}}}{{R}_{0}}}{4 {π}^{2} {ρ}_{L}} ) ( \frac{\frac{1}{{f}_{1 max}^{2}} + \frac{1}{{f}_{1 min}^{2}}}{2} ) - {R}_{0}^{2} ( 1 - \frac{E}{2} ) ] \qquad ( 56 )$$

Equation (56) provides a general case estimator for the attached solids mass loading of a bubble of known equilibrium radius.

Equations (50)-(53) may themselves be inverted to provide an estimator for encapsulating layer dilatational viscosity as a function of bubble equilibrium radius and the frequencies of the fundamental resonance maximum and interference minimum in the receiver total average power. It can be shown by rearranging Eqns. (51) and (53) that the encapsulating layer dilatational viscosity can be written as:

$${κ}_{S} = {R}_{0} \{ \frac{{R}_{0}}{4} \sqrt{( \frac{{Θ}^{2} - 1}{2 Θϛ} ) E {ρ}_{L} [ 3 κ {p}_{0} + \frac{2 {σ}_{0}}{{R}_{0}} ( 3 κ - 1 ) + \frac{4 {χ}_{0}}{{R}_{0}} ]} - μ \} \qquad ( 57 )$$

Here Eqn. (50) is used to write the dimensionless coefficient Θ as

$$Θ = [ \frac{3 κ {p}_{0} + \frac{2 {σ}_{0}}{{R}_{0}} ( 3 κ - 1 ) + \frac{4 {χ}_{0}}{{R}_{0}}}{4 {π}^{2} {ρ}_{L} {ER}_{0}^{2}} ] ( \frac{1}{{f}_{1 max}^{2}} - \frac{1}{{f}_{1 min}^{2}} ) \qquad ( 58 )$$

Parameter estimation for a ‘clean’ bubble is of interest in many applications. Equation (54) may be rearranged for zero attached solids mass to provide an estimator for bubble equilibrium radius as:

$${R}_{0} = \frac{1}{2 π {f}_{1 max}} \sqrt{\frac{3 κ {p}_{0} + \frac{2 {σ}_{0}}{{R}_{0}} ( 3 κ - 1 ) + \frac{4 {χ}_{0}}{{R}_{0}}}{{ρ}_{L} [ 1 - \frac{E}{2} ( 1 - Θ ) ]}} \qquad ( 59 )$$

This is an extended form of the classical Minnaert relationship between the ‘clean’ bubble radius and the acoustic resonance frequency. In this case, even though the bubble is unloaded it may be encapsulated by an elastic layer. The bubble equilibrium radius in Eqn. (59) explicitly depends on the liquid viscosity and any surface layer dilatational viscosity.

Equation (56) may also be rearranged for the case of zero attached solids mass to give:

$${R}_{0} = \frac{1}{2 π} \sqrt{\frac{1}{2} ( \frac{1}{{f}_{1 max}^{2}} + \frac{1}{{f}_{1 min}^{2}} )} \sqrt{\frac{3 κ {p}_{0} + \frac{2 {σ}_{0}}{{R}_{0}} ( 3 κ - 1 ) + \frac{4 {χ}_{0}}{{R}_{0}}}{{ρ}_{L} [ 1 - \frac{E}{2} ]}} \qquad ( 60 )$$

Equation (60) is an alternative estimator for the equilibrium radius of a ‘clean’ but possibly encapsulated bubble. It does not require a priori knowledge of any encapsulating layer dilatational viscosity.

In the case of a ‘clean’ bubble, the encapsulating layer dilatational viscosity can be found via the general case estimator (Eqn. (57)) for an equilibrium bubble radius itself estimated from

Eqn. (60). Alternatively, the encapsulating layer dilatational viscosity can also be found from the ratio of Eqns. (45) and (46) in the case Γₚ*=1 (a ‘clean’ bubble), leading to the estimator:

$${κ}_{S} = {R}_{0} \{ \frac{{R}_{0}}{4 ϛ} \sqrt{\frac{{ρ}_{L}}{2} [ 3 κ {p}_{0} + \frac{2 {σ}_{0}}{{R}_{0}} ( 3 κ - 1 ) + \frac{4 {χ}_{0}}{{R}_{0}} ] [ \frac{{( 2 - E )}^{2} - {ϛ}^{2} {E}^{2}}{2 - E} ]} - μ \} \qquad ( 61 )$$

Equation (61) provides an estimate for the encapsulating layer dilatational viscosity of a ‘clean’ bubble of known equilibrium radius, for given frequencies of the fundamental resonance maximum and interference minimum, gas polytropic index, bubble surface tension parameters, monitoring system geometry, and liquid density ρ_{L}, and viscosity.

Specific Case Solutions for Bubble Size and Solids Mass Loading for a Free Bubble and Negligible Liquid Viscosity

Equations (47) and (48) can be combined to provide an estimator for the bubble equilibrium radius (independent of the attached solids mass loading) in the case of a free bubble where there are negligible liquid viscosity and elastic layer compression modulus effects on the frequencies of the extrema of the total average power of the pressure at the receiver. This estimator can also be found directly from Eqn. (50) for nil values of liquid viscosity and shell layer dilatational viscosity (leading to Δ=0 via Eqn. (53)) plus nil shell elastic layer compression modulus. The equilibrium bubble radius in these circumstances is given by the following expression:

$${R}_{0} = \frac{1}{2 π} \sqrt{\frac{1}{{f}_{1 max}^{2}} - \frac{1}{{f}_{1 min}^{2}}} \sqrt{\frac{3 κ {p}_{0} + \frac{2 {σ}_{0}}{{R}_{0}} ( 3 κ - 1 )}{{ρ}_{L} E}} ; ( {f}_{min} > {f}_{max} ) \qquad ( 62 )$$

This estimator for bubble equilibrium radius is also dependent on knowledge of the distance from the bubble to either the acoustic source or the (hydrophone) receiver (see Eqn. (49)). It should be noted that Eqn. (62) holds both in cases where attached solids are present or absent.

The attached solids mass loading in this case can be found from Eqns. (47) and (48) as either of the following equivalent expressions:

$$\begin{matrix}{M}_{S} = \frac{{R}_{0}}{δ} ( \frac{3 κ {p}_{0} + \frac{2 {σ}_{0}}{{R}_{0}} ( 3 κ - 1 )}{4 {π}^{2} {ρ}_{L} {f}_{1 max}^{2}} - {R}_{0}^{2} ) \\ and & ( 63 ) \\ {M}_{S} = {R}_{0} \frac{[ 3 κ {p}_{0} + \frac{2 {σ}_{0}}{{R}_{0}} ( 3 κ - 1 ) ]}{4 {π}^{2} {ρ}_{L} δ} [ \frac{1}{{f}_{1 max}^{2}} - \frac{1}{E} ( \frac{1}{{f}_{1 max}^{2}} - \frac{1}{{f}_{1 min}^{2}} ) ] & ( 64 )\end{matrix}$$

Equation (63) for attached solids mass loading can be shown (utilising Eqn. (47) to estimate the unloaded bubble resonant response frequency) to be equivalent to Eqn. (14) which was derived to estimate monolayer attached high density solids mass loading from solids loaded bubble resonant response frequency for a priori known bubble equilibrium radius and resonant response frequency at nil attached solids mass loading.

The case of bubble size for nil attached solids is again of interest. Equations (47) and (63) may both be rearranged for the case of zero attached solids mass as follows:

$${R}_{0} = \frac{1}{2 {πf}_{1 max}} \sqrt{\frac{3 κ {p}_{0} + \frac{2 {σ}_{0}}{{R}_{0}} ( 3 κ - 1 )}{{ρ}_{L}}} \qquad ( 65 )$$

Again, this is the classical Minnaert relationship, between the equilibrium radius of a ‘clean’, unencapsulated bubble and the fundamental frequency of acoustic resonance (usually used to describe a freely oscillating bubble), here extended to include surface tension.

Introducing Eqn. (65) into (62) leads to the following expression for the equilibrium radius of the bubble in the nil attached solids case:

$${R}_{0} = \frac{1}{2 {πf}_{1 min}} \sqrt{\frac{3 κ {p}_{0} + \frac{2 {σ}_{0}}{{R}_{0}} ( 3 κ - 1 )}{{ρ}_{L} ( 1 - E )}} \qquad ( 66 )$$

Combining Eqns. (65) and (66) leads to the following expression for the dimensionless coefficient E in the case of a ‘clean’, free bubble in a liquid with negligible viscosity:

$$E = 1 - {( \frac{{f}_{1 max}}{{f}_{1 min}} )}^{2} \qquad ( 67 )$$

Introducing Eqn. (67) into Eqns. (62) and (66) results in the extended Minnaert relationship of Eqn. (65) as expected.

Equation (62) can be used to estimate the bubble equilibrium radius for arbitrary attached solids mass loading in the specific case of an unencapsulated bubble and negligible liquid viscosity effect on bubble size. It requires reliable experimental estimates of the frequencies of the fundamental resonance maximum and interference minimum of the acoustic receiver average power response. Either of Eqns. (63) or (64) can then be used to estimate bubble attached solids mass loading. These expressions are valid for a bubble at known distances from a point acoustic source and a suitable acoustic receiver when subject to low amplitude forced acoustic excitation at frequencies near the fundamental resonance frequency. Equations (62), (65) and (66) can all be used to estimate the equilibrium size of an unloaded bubble.

Additional Estimators Based on Resonance Response at Double the Excitation Frequency

The use of two acoustic features (frequencies of the fundamental resonance maximum and interference minimum in receiver total average power) as inputs to the bubble parameter inverse problem only permits two distinct parameters of a single bubble to be uniquely estimated. Hence bubble equilibrium radius and attached solids mass loading can be estimated for known values of the encapsulating layer dilatational viscosity and the distance of the bubble from the source or receiver. Alternatively, bubble radius and encapsulating layer dilatational viscosity can be uniquely estimated for nil attached solids mass loading. However, it should be noted that the frequency of the resonance maximum associated with receiver total average acoustic power at double the excitation frequency could also provide an alternative estimator for bubble size and attached mass in the case of O(1-10) micron-sized bubbles. A turning points analysis of Eqn. (40) may lead to closed-form analytical expressions for the frequency of the second harmonic acoustic response maximum as a function of bubble and monitoring system properties. Alternatively, Eqn. (40) can be used to plot the receiver total average power at double the excitation frequency as a function of receiver frequency. This analysis reveals that the frequency of the second harmonic maximum is close to double the first harmonic peak resonance frequency associated with a bubble of the same equilibrium size and attached solids mass loading bubble but with negligible encapsulating layer and liquid viscosity, regardless of whether the bubble is actually free or has an encapsulating layer. This result suggests that the peak frequency f₂ₘₐₓ of the maximum total average power in the receiver pressure field associated with the second harmonic of bubble resonance for a mildly acoustically excited solids-loaded (and possibly encapsulated) bubble can be written as follows:

$${f}_{2 max}^{2} \approx \frac{3 κ {p}_{0} + \frac{2 {σ}_{0}}{{R}_{0}} ( 3 κ - 1 ) + \frac{4 {χ}_{0}}{{R}_{0}}}{{π}^{2} {ρ}_{L} {Γ}_{p}^{*} {R}_{0}^{2}} \qquad ( 68 )$$

Equation (68) leads to the following additional estimator for the attached solids mass loading in terms of the second harmonic peak frequency f₂ₘₐₓ, bubble equilibrium radius and other system properties:

$${M}_{S} \approx \frac{{R}_{0}}{δ} ( \frac{3 κ {p}_{0} + \frac{2 {σ}_{0}}{{R}_{0}} ( 3 κ - 1 ) + \frac{4 {χ}_{0}}{{R}_{0}}}{{π}^{2} {ρ}_{L} {f}_{2 max}^{2}} - {R}_{0}^{2} ) \qquad ( 69 )$$

It should be noted that f₂ₘₐₓ≠2f₁ₘₐₓ for O(1-10) micron equilibrium radius bubbles in water. However, as bubble size increases further the frequency of the second harmonic resonance maximum converges on double the frequency of the fundamental resonance maximum and does not provide any additional information to assist in bubble parameter estimation. Equation (69) thus reverts to Equation (63). The implications of this result are that only two bubble properties (e.g. R₀ and M_{S}) can be simultaneously determined for larger (macro)bubbles from either of the two characteristics f₁ₘᵢₙ and f₁ₘₐₓ or f₁ₘᵢₙ and f₂ₘₐₓ.

The estimators for attached solids mass loading in Eqns. (56) and (69) can now be equated to obtain an additional general case estimator for bubble equilibrium radius at arbitrary attached solids mass loading and encapsulating layer dilatational viscosity. This bubble equilibrium radius estimator can be written as:

$${R}_{0} \approx \frac{1}{2 π} \sqrt{2 [ \frac{4}{{f}_{2 max}^{2}} - \frac{1}{2} ( \frac{1}{{f}_{1 max}^{2}} + \frac{1}{{f}_{1 min}^{2}} ) ]} \sqrt{\frac{3 κ {p}_{0} + \frac{2 {σ}_{0}}{{R}_{0}} ( 3 κ - 1 ) + \frac{4 {χ}_{0}}{{R}_{0}}}{{ρ}_{L} E}} \qquad ( 70 )$$

The equilibrium bubble radius in Eqn. (70) is a function of three features of the receiver total power associated with forced acoustic resonance interference spectroscopy. These features are the frequencies of the fundamental resonance maximum, interference minimum and second harmonic maximum in receiver total average power. As expected, inserting f₂ₘₐₓ=2f₁ₘₐₓ in Eqn. (70) simply reduces it to a reduced form of Eqn. (50) for the case Θ=1 (nil liquid viscosity and shell dilatational viscosity). Equations (57) and (69) can now be used to uniquely estimate the dilatational viscosity of any encapsulating layer and attached solids mass loading, respectively.

Simulation Results - Example Solutions of the Forward Problem for Acoustic Response as a Function of Bubble Characteristics

Receiver Total Average acoustic Power as a function of frequency

Free Bubble—loaded

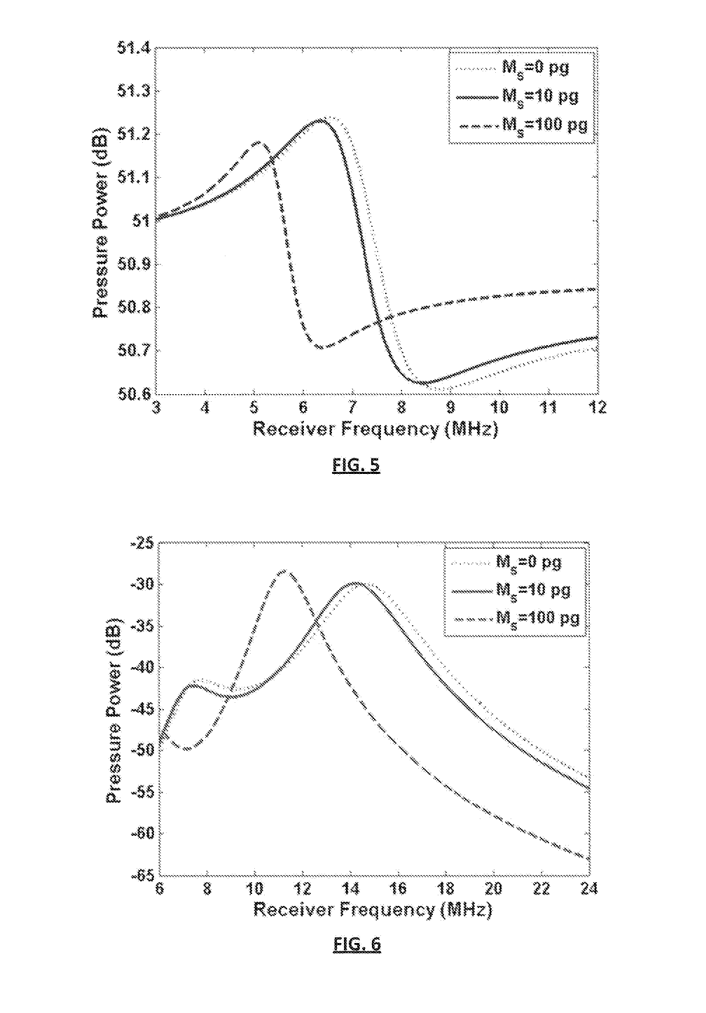

Simulation results are presented here for the response of a millimetre sized unencapsulated but attached solids mass loaded bubble to mild acoustic excitation. FIGS. 3 and 4 show model results for receiver total average acoustic power associated with first and second forced harmonic responses respectively, as a function of receiver frequency. In each plot separate curves are shown for three different attached solids mass loadings (0, 1 and 10 mg of solid particles of density 2200 kgm⁻³ (simulating glass balloting). In this case the bubble is 1 mm radius and the distances from the bubble centre to both the point acoustic source and hydrophone receiver are both 10 mm (in opposite directions). The acoustic excitation has pressure amplitude of 100 Pa at the bubble location and is sinusoidal with frequencies over the range 2.5-7.5 kHz. The surface tension is 7.2e-2 kgs⁻², appropriate for air bubbles in water. The gas polytropic index is 1.4, as appropriate for air bubbles. The liquid viscosity is 8.94e-04 kgm⁻¹ s⁻¹, as appropriate for water. Smaller values of liquid viscosity do not change the profiles of total receiver pressure power as a function of excitation frequency.

Peaks in the pressure power response spectrum are readily apparent at the fundamental frequency and second harmonic of bubble forced resonance. The frequency of the peaks clearly decreases with attached solids mass loading (and bubble equilibrium size). Hence the resonance peak frequencies could potentially be used to estimate bubble parameters such as size, attached solids mass loading and encapsulating layer dilatational viscosity (additionally the distance between the bubble and either the source or receiver). Minima in receiver pressure power just above both the fundamental and second harmonic resonance frequencies are also very clear. Again, these minima are due to destructive interference between the source acoustic beam and the bubble acoustic response as detected at the receiver. Both the location of these minima could be related to bubble parameters such as size, attached solids mass loading and encapsulating layer dilatational viscosity. In this analysis only the frequency location of the minimum just above the fundamental resonance maximum response are used for bubble parameter estimation. It should be noticed that in practical application, broadband excitation of bubbles could lead to overlapping first harmonic and second harmonic responses due to the simultaneous excitation at multiple frequencies. In this case, the total average acoustic power at any frequency within the range of overlapping first and second harmonic frequencies would actually consist of incoherently summed excitation frequency and double excitation pressure contributions.

The fundamental and second harmonic peaks due to resonant excitation in this case actually correspond to bubble wall radial oscillations that exceed the bounds of validity of the regular perturbation model. Hence the (relative) strength of the receiver pressure signal at the fundamental and second harmonic frequencies may not be reliable for accurately determining the solids mass loading of a bubble. However, the analytical solutions for frequencies of the fundamental and second harmonic maxima and related interference minima are unaffected by the strengths of both the source and the bubble resonant response and vary strongly with both the attached solids mass loading and bubble size. This has been confirmed by examination of simulation results for the fundamental and second harmonic total average acoustic power as a function of receiver frequency, varying the source amplitude over a 1-10⁵ Pa range. It is anticipated that estimating bubble parameters from the frequencies of features in the forced acoustic spectrum at the receiver is valid and accurate over a much broader range of source amplitudes than any model based on the strengths of the harmonics at the receiver.

Encapsulated Microbubble—loaded

Simulation results are presented here for the response of a micron sized encapsulated and attached solids mass loaded microbubble to mild acoustic excitation. FIGS. 5 and 6 show model results for total receiver pressure power associated with first and second forced harmonic responses respectively, as a function of receiver frequency. In each plot separate curves are shown for three different attached solids mass loadings (0, 10 and 100 pg) for an attached layer composed entirely of solids of density 1100 kgm⁻³, simulating the mass effect of a lipid encapsulating layer. The encapsulating layer dilatational viscosity is 2.4×10⁻⁹ kgs⁻¹ and the shell elastic layer compression modulus is 0.38 kgs⁻², as appropriate for the Definity™ ultrasound contrast agent. In this case the bubble is 1 μm radius in accordance with an optically determined mean size of a population of Definity ultrasound contrast agent. The distances from the bubble centre to both the point acoustic source and hydrophone receiver are both 100 μm (in opposite directions). The acoustic excitation has pressure amplitude of 1000 Pa at the bubble location and is sinusoidal with frequencies over the range 3-12 MHz. The equilibrium surface tension is taken as 7.2e-2 kgs⁻². The gas polytropic index is 1.06, as appropriate for the C₃F₈ bubble core used in Definity ultrasound contrast agent. The liquid viscosity is 8.94e-04 kgm⁻¹s⁻¹, as appropriate for water.

Peaks are again apparent in the first harmonic (˜5-7 MHz) and second harmonic (˜11-15 MHz) total average acoustic power response spectra. However, the peaks are much broader and lower amplitude in the case of an encapsulated microbubble in comparison to a millimetre sized free bubble. This is the result of relatively strong total viscosity acoustic damping effects for micron sized bubbles. This viscous damping is due both to the liquid viscosity and the encapsulating layer dilatational viscosity. Despite this, the frequency location of the peaks can still be used to estimate bubble parameters such as size, attached solids mass loading and encapsulating layer dilatational viscosity (additionally the distance between the bubble and either the source or receiver). It should be noted that as expected, the frequency location of the peaks is strongly increased by the encapsulating layer elastic layer compression modulus [see Eqn. (45) and Eqn. (68)]. A secondary maximum at ˜5-7 MHz is apparent in FIG. 6) in the second harmonic responses. This is at frequencies near (but not the same as) those associated with the first harmonic (excitation frequency) response. An interference minimum in receiver pressure power is clear in FIG. 5) above the fundamental resonance frequency. The location of this minimum can also be related to bubble parameters such as size, attached solids mass loading and encapsulating layer dilatational viscosity. There is no local minimum in FIG. 6) at frequencies above the second harmonic maximum response.

The Frequencies of the Fundamental Maximum and Interference Minimum as a function of Bubble Size and Solids Loading

An example is provided of the frequencies of the fundamental resonance maximum and interference minimum of the receiver total average acoustic power as a function of bubble equilibrium radius and attached solids mass loading. These model predictions are based on Eqns. (47) and (48) in the case of a free bubble and negligible liquid viscosity effect on the acoustic power response.

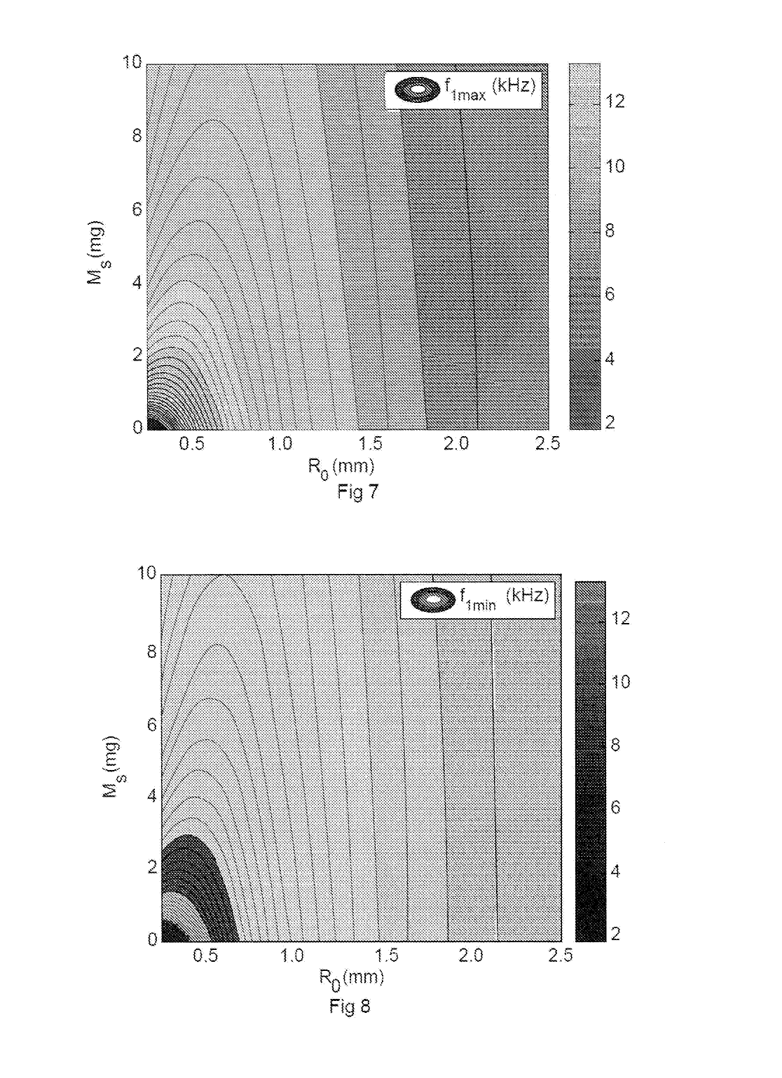

FIG. 7 is a filled contour plot of the frequency of the maximum (near the bubble resonance fundamental frequency) in the acoustic receiver average pressure power spectrum as a function of the equilibrium bubble radius and attached solids mass loading in the case of a free bubble and negligible liquid viscosity effect on bubble resonance frequencies. The plot axis boundaries are R₀=0.25−2.5 mm and M_{S}=0−10 mg.

As expected, the frequency of maximum acoustic power varies strongly with both bubble equilibrium radius and attached solids mass loading. The maximum possible value for f₁ₘₐₓ is on the R₀ axis near the origin. A feature of considerable interest is a ‘ridge’ of maximal frequency at any given solids mass loading that extends in a positive direction in terms of both bubble equilibrium radius and attached solids mass loading from the R₀ axis near the origin of the plot. The significance of this ridge is that for any given solids mass loading there may be two values of bubble radius that result in the same frequency of maximal acoustic response. Even if the amount of solids attached to the bubble is a priori known, two possible sizes of bubble could produce the same maximal acoustic power response frequency. This non-uniqueness is a result of the solids mass attached to the bubble. In situations of bubbles loaded with even a known amount of solids, it is necessary to measure both f₁ₘₐₓ and fₘᵢₙ in order to uniquely estimate the bubble size.

An equation can be found that describes the ‘ridge’ of maximal frequency response near the fundamental resonance frequency. The position of maximal f₁ₘₐₓ for any given M_{S} can be found by finding the turning points R_{0,f1max} of Eq. (47) with respect to bubble equilibrium radius. This leads to the cubic equation:

$${R}_{0 , f 1 max}^{3} + \frac{σ}{3 κ {p}_{0}} ( 3 κ - 1 ) {R}_{0 , f 1 max}^{2} - \frac{δ {M}_{S}}{2} = 0 \qquad ( 71 )$$

An analytical solution can be found to Eqn. (71). However, more insight can be obtained by considering the case of negligible surface tension. In this case, the ‘ridge’ of acoustic maximal frequency response is described by the line:

$${R}_{0 , f 1 max} = {( \frac{δ {M}_{S}}{2} )}^{1 \text{/} 3} \qquad ( 72 )$$

A bifurcation appears from a unique to dual solution for bubble equilibrium radius (as derived from the acoustic maximal response frequency alone) as soon as solids mass is attached to the bubble. The solutions for bubble equilibrium size based on the frequency of the fundamental resonant response alone are unique only in the case of ‘clean’ bubbles.

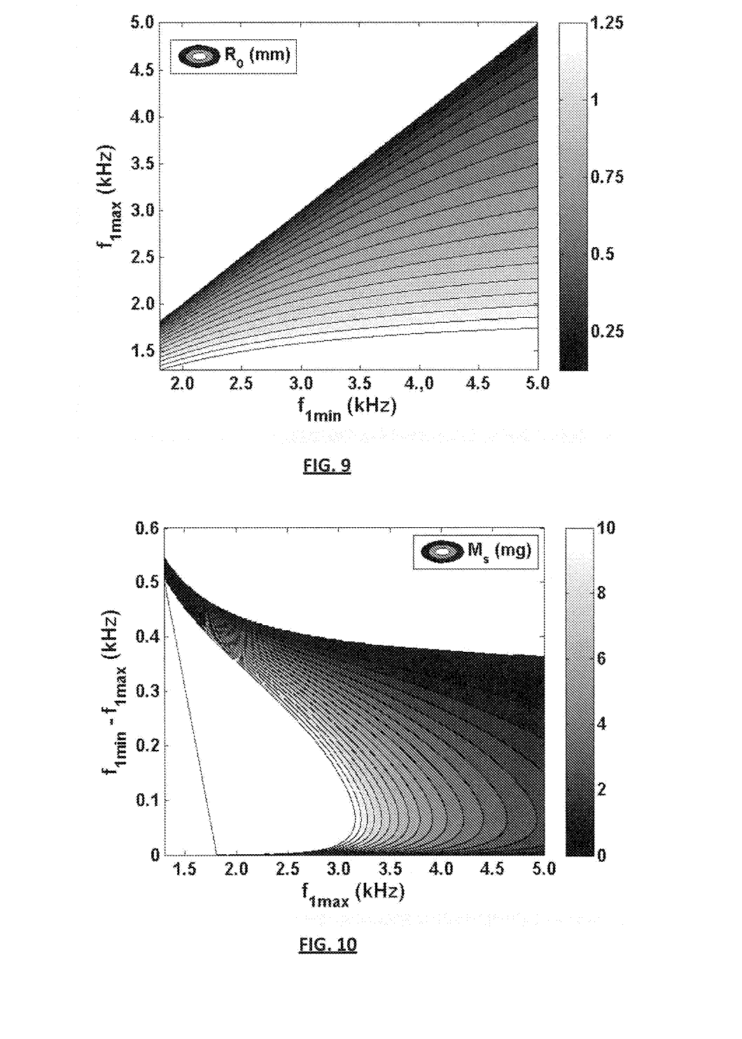

FIG. 8 is a filled contour plot of the frequency of the minimum (near the resonance fundamental frequency) in the acoustic receiver average pressure power spectrum as a function of the equilibrium bubble radius and attached solids mass loading. Again, non-unique solutions for bubble radius (in the case of a solids loaded bubble) are possible if the prediction is based only on the frequency of the interference minimum near the fundamental resonant response.

Example Solutions of the Inverse Problem for Bubble Size and Attached Solids Mass Loading as a Function of Frequencies of Extrema in the Receiver Total Average Acoustic Power

An example is provided of the estimated equilibrium bubble size and attached solids mass loading associated with the frequencies of the fundamental resonance maximum and interference minimum of the receiver total average acoustic power. These model predictions are based on Eqns. (62) and (63) in the case of a free bubble and negligible liquid viscosity effect on the acoustic power response. The Newton-Raphson iterative method is used to solve Eqn. (62) for R₀ (quartic in bubble equilibrium radius). This is increasingly important at small bubble radii (O(1) μm or less) where surface tension has an important effect on bubble acoustic oscillations.

FIG. 9 is a filled contour plot of bubble radius as a function of the frequencies of the fundamental resonance maximum and interference minimum received total average average acoustic power. The plot axis boundaries are f₁ₘᵢₙ=1.8−5.0 kHz and f₁ₘₐₓ=1.3−5.0 kHz. Contours of bubble equilibrium radius are over the range 0.25-2.5 mm for attached solids mass loading over the range 0-10 mg. The solutions for bubble equilibrium radius are unique for this range of maximal and minimal first harmonic (excitation frequency) acoustic power response frequencies.

FIG. 10 is a filled contour plot of bubble attached solids mass loading as a function of the frequencies of the first harmonic resonance maximum and the difference between the frequencies of the first harmonic interference minimum and resonance maximum received total average acoustic power. The plot axis boundaries are f₁ₘₐₓ=1.3−5.0 kHz and f₁ₘᵢₙ−f₁ₘₐₓ=0.0−0.6 kHz. Contours of bubble attached solids mass loading are over the range 0-10 mg for bubble equilibrium radius over the range 0.25-2.5 mm

The solutions for bubble attached solids mass loading are unique for this range of maximal and minimal first harmonic acoustic power response frequencies. However, the range of f₁ₘᵢₙ and fₘₐₓ for which there are solutions is restricted to a band and the contours of attached solids loading are tightly packed in some regions of (fₘᵢₙ, f₁ₘₐₓ) space. Experimentally, a higher accuracy in frequency resolution of the minimum and maximum first harmonic acoustic pressure power response would be needed for the same relative error in estimation of attached solids mass loading in comparison to bubble equilibrium radius.

As shown in FIG. 10, plotting the attached solids mass as a function of (f₁ₘₐₓ, f₁ₘᵢₙ−f₁ₘₐₓ) clearly demonstrates the complexity of the relationship between attached solids mass and the acoustic resonance interference first harmonic extrema frequencies. At relatively low resonance maximum frequency and low difference between the frequencies of the acoustic power extrema the high attached solids mass is a slowly varying function. The triangular region outside the contours at lower values of f₁ₘₐₓis associated with attached solids mass loadings slightly above the 10 mg upper limit of the contour plot. Relatively large changes in the frequency of the acoustic power resonance maximum and difference between the minimum and maximum frequency are associated with relatively small changes in the attached solids mass in this region. In these circumstances, observations of the resonance frequency and difference between resonance and interference minimum frequency would lead to a robust prediction of attached solids mass. However, at very low values for the difference between the acoustic response extrema frequencies and also at relatively low resonance frequency but high frequency difference, the contours of added mass are densely packed. In these circumstances, there would be much larger error margins on predictions of attached solids mass loading.

Estimation of the Properties of a Liquid-Like Medium Based on Bubble Active Acoustic Response

The inventor has additionally determined that the active acoustic response of a gaseous bubble in a liquid-like medium, can in turn be used to estimate certain properties of the liquid-like medium. Estimators for the properties of a liquid-like medium based on the active acoustic response of a ‘clean’ (nil attached solids) bubble are here presented for two cases representative of negligible and significant viscosities for the combined liquid and any bubble surface layer.
1. A ‘Clean’ Bubble (Nil Attached Solids) and Negligible Liquid and Bubble Surface Dilatational Viscosities

Previously presented equations (49) and (67) can be combined to derive the following estimator for bubble equilibrium radius based purely on the first two characteristics (frequencies of the resonance fundamental maximum and interference minimum responses) and the geometry of the active monitoring system:

$${R}_{0} = \frac{[ 1 - {( \frac{{f}_{1 max}}{{f}_{1 min}} )}^{2} ]}{[ \frac{1}{r} + \frac{1}{{r}_{SB}} ]} . \qquad ( 73 )$$

Equation (65) then allows the density of the surrounding liquid-like medium (denoted here as σ_{Sl}) to be estimated from R₀, f₁ₘₐₓ, the medium ambient pressure p₀, surface tension at equilibrium bubble radius σₒ and the gas polytropic index κ as follows (assuming nil elastic compression modulus for an unencapsulated bubble):

$${ρ}_{SI} = \frac{3 κ {p}_{0} + \frac{2 {σ}_{0}}{{R}_{0}} ( 3 κ - 1 )}{4 {π}^{2} {R}_{0}^{2} {f}_{1 max}^{2}} . \qquad ( 74 )$$

Assuming that the slurry (liquid-like medium) between the bubble and the acoustic receiver is two phase, consisting of solid (particle) and pure liquid phases with densities ρₛ and ρ_{L}, respectively, the following equation for φₛ, the solids volumetric fraction, is readily derived:

$${φ}_{S} = \frac{{ρ}_{SI} - {ρ}_{L}}{{ρ}_{S} - {ρ}_{L}} . \qquad ( 75 )$$

Equations (73), (74) and (75) can be used to estimate the bubble equilibrium size, liquid-like medium density and solids volumetric fraction of the medium respectively, from the bubble active acoustic response characteristics f₁ₘₐₓ and f₁ₘᵢₙ. These equations apply in the case of a ‘clean’ (nil attached solids), unencapsulated bubble when there is negligible influence of the viscosity of the medium on the bubble active acoustic response characteristics.
2. A ‘Clean’ Bubble (Nil Attached Solids) and Significant Liquid or Bubble Surface Dilatational Viscosities

Equation (68) allows the density of the surrounding liquid-like medium in the case of a ‘clean’ bubble to be estimated from R₀, f₂ₘₐₓ, the medium ambient pressure p₀, surface tension at equilibrium bubble radius σₒ, encapsulating layer elastic compression modulus χ₀ and the gas polytropic index κ to be written as follows:

$${ρ}_{SI} \approx \frac{3 κ {p}_{0} + \frac{2 {σ}_{0}}{{R}_{0}} ( 3 κ - 1 ) + \frac{4 χ0}{R0}}{{π2f}_{2 max}^{2} {R}_{0}^{2}} . \qquad ( 76 )$$

Equation (76) can be inserted into Eqn. (70) to derive the following equation for the bubble equilibrium radius based purely on the first three characteristics (frequencies of the resonance fundamental maximum, interference minimum and second harmonic maximum responses) and the geometry of the active monitoring system:

$${R}_{0} \approx \frac{[ 2 - \frac{{f}_{2 max}^{2}}{4} ( \frac{1}{{f}_{1 max}^{2}} + \frac{1}{{f}_{1 min}^{2}} ) ]}{[ \frac{1}{r} + \frac{1}{{r}_{SB}} ]} . \qquad ( 77 )$$

Equation (77) is applicable for arbitrary medium viscosity and bubble encapsulating layer dilatational viscosity. It should be noted that in cases where the liquid and bubble dilatational viscosities are negligible, f₂ₘₐₓ=2f₁ₘₐₓ, resulting in Eqn. (77) being reduced to Eqn. (73) as expected.

A net viscosity μ of the combined medium and the encapsulating layer around the bubble can be defined in terms of the shear viscosity μ of the medium and the surface dilatational viscosity κ_{S} of any elastic layer encapsulating the bubble by:

$${μ}^{′} = μ + \frac{{κ}_{S}}{{R}_{0}} . \qquad ( 78 )$$

The net viscosity can then be estimated by a rearrangement of Eqn. (61) as follows:

$${μ}^{′} = \frac{{R}_{0}}{4 ϛ} \sqrt{\frac{{ρ}_{SI}}{2} [ 3 κ {p}_{0} + \frac{2 {σ}_{0}}{{R}_{0}} ( 3 κ - 1 ) + \frac{4 {χ}_{0}}{{R}_{0}} ] [ \frac{{( 2 - E )}^{2} - {ϛ}^{2} {E}^{2}}{2 - E} ]} . \qquad ( 79 )$$

Here the dimensionless coefficient E defined by Eqn. (49) is defined by use of Eqn. (77) as

$$E = 2 - \frac{{f}_{2 max}^{2}}{4} ( \frac{1}{{f}_{1 max}^{2}} + \frac{1}{{f}_{1 min}^{2}} ) . \qquad ( 80 )$$

The coefficient ζ, is defined by Eqn. (52) as follows:

$$ϛ = \frac{1 + {\overline{ω}}^{2}}{1 - {\overline{ω}}^{2}} ; \\ \overline{ω} = \frac{{f}_{1 max}}{{f}_{1 min}} . \qquad ( 81 )$$

Equations (77), (76), (79) and (75) are used to estimate the bubble equilibrium size, liquid-like medium density, net viscosity and solids volumetric fraction of the medium respectively, from the bubble active acoustic response characteristics f₁ₘₐₓ, f₁ₘᵢₙ and f₂ₘₐₓ. These equations apply in the case of a ‘clean’ (nil attached solids), possibly encapsulated bubble when there is significant influence of the net viscosity of the bubble-medium system on the bubble active acoustic response characteristics.

Experimental Examples of the Method of Bubble Acoustic Resonance Interference Monitoring

A series of bubble active acoustic monitoring experiments were conducted, looking at the acoustic response of appropriately insonated bubbles of the order of millimeter radius.

In a first series, the experiments were performed with single bubbles loaded with attached solids. Single air bubbles were generated on the tip of a syringe in a glass water tank, loaded with attached solids (hydrophobic Balloting). The bubble was induced to detach from the syringe orifice and then insonated with a sweep (chirp) acoustic signal (2.8-3.8 kHz) from a nearby acoustic transducer. The acoustic response of the rising bubble was detected by a nearby broadband hydrophone. Photographic equipment was used to visually estimate bubble size and attached solids mass loading for comparison purposes.

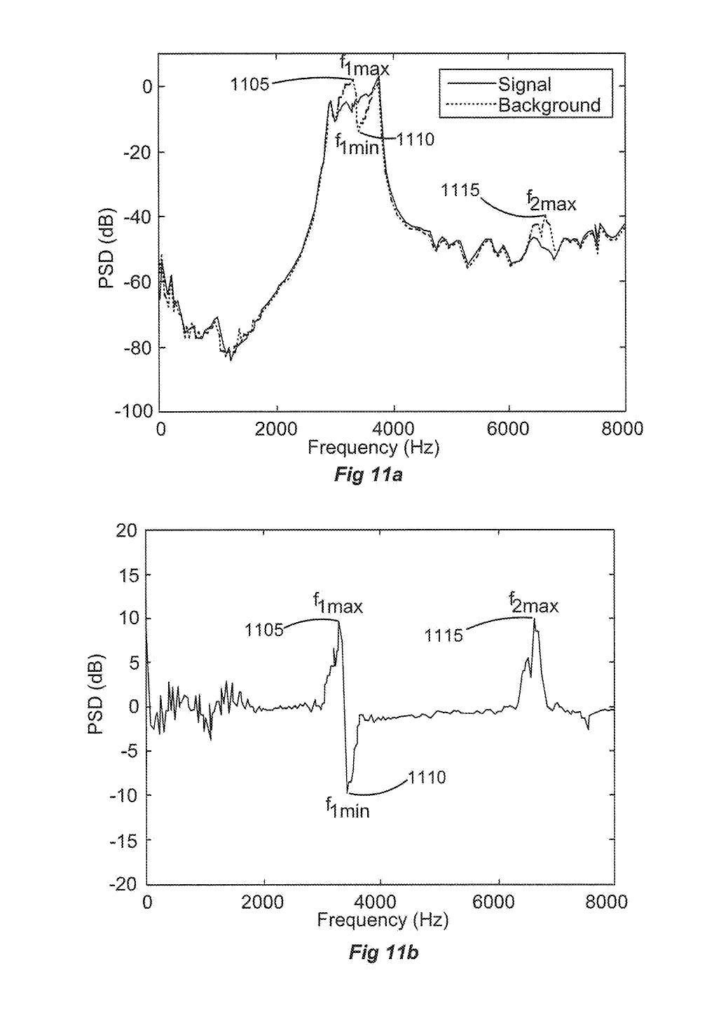

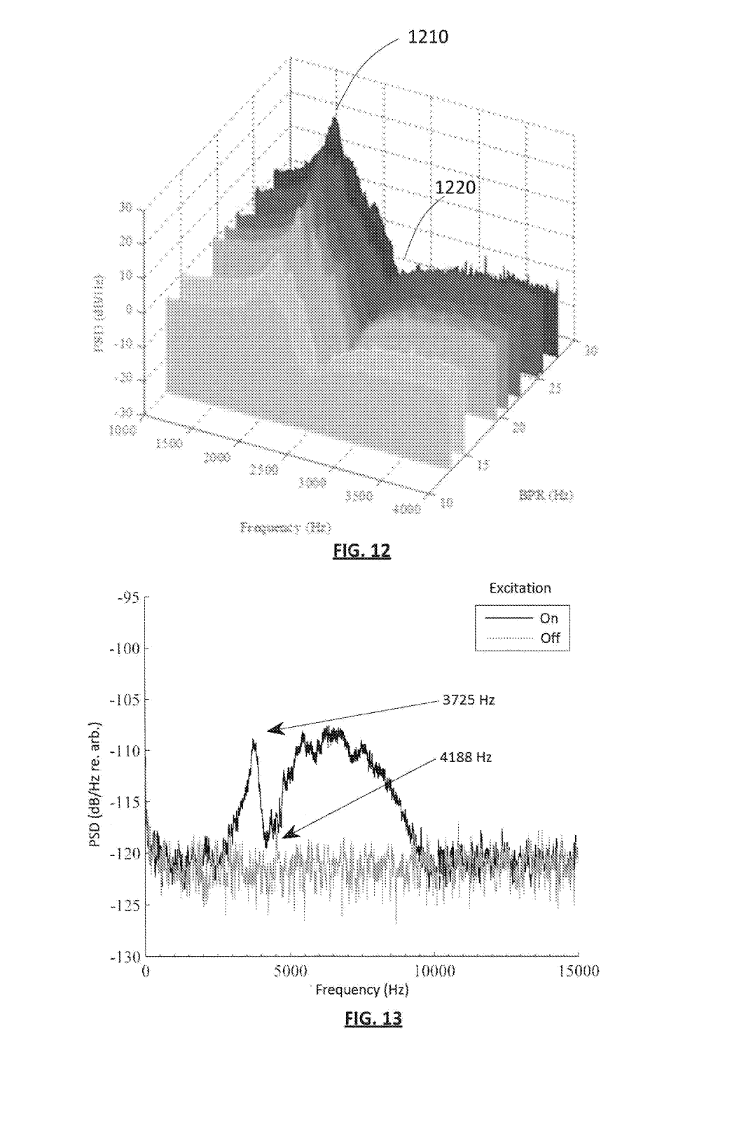

FIG. 11a illustrates a power spectrum of an archetypal acoustic response of a bubble (˜0.9 mm equilibrium radius and ˜0.85 mg attached solids) as a function of frequency. The acoustic power response is dominated by the frequency region associated with the source sweep signal.

The frequency locations of the fundamental excitation maximum (f_{1 max}) 1105, interference minimum (f₁ₘᵢₙ) 1110, and second harmonic maximum (f₂ₘₐₓ) total acoustic response 1115 are indicated on the graph. The bubble response power spectrum normalized by the background (i.e. where the bubble was absent) power spectrum due to the source beam is shown in FIG. 11(b), which very clearly demonstrates the locations of the respective extrema in the total acoustic response signal.

The frequency locations of the extrema of the receiver power spectral response due to the interaction of the insonated bubble response and source beam are the acoustic parameters used for estimation of bubble properties.

In a second series of experiments, a single stream or column of rising air bubbles of similar size (each of ˜0.9 mm equilibrium radius) was generated by pumping small quantities of air through a syringe mounted near the bottom of a glass water tank. These rising bubbles were insonated with a repeated burst acoustic signal and the response detected by a broadband hydrophone mounted slightly higher in the tank, roughly in line-of-sight between the source and the bubbles (transmission configuration). The bubble production rate was varied during these experiments and acoustic data gathered.

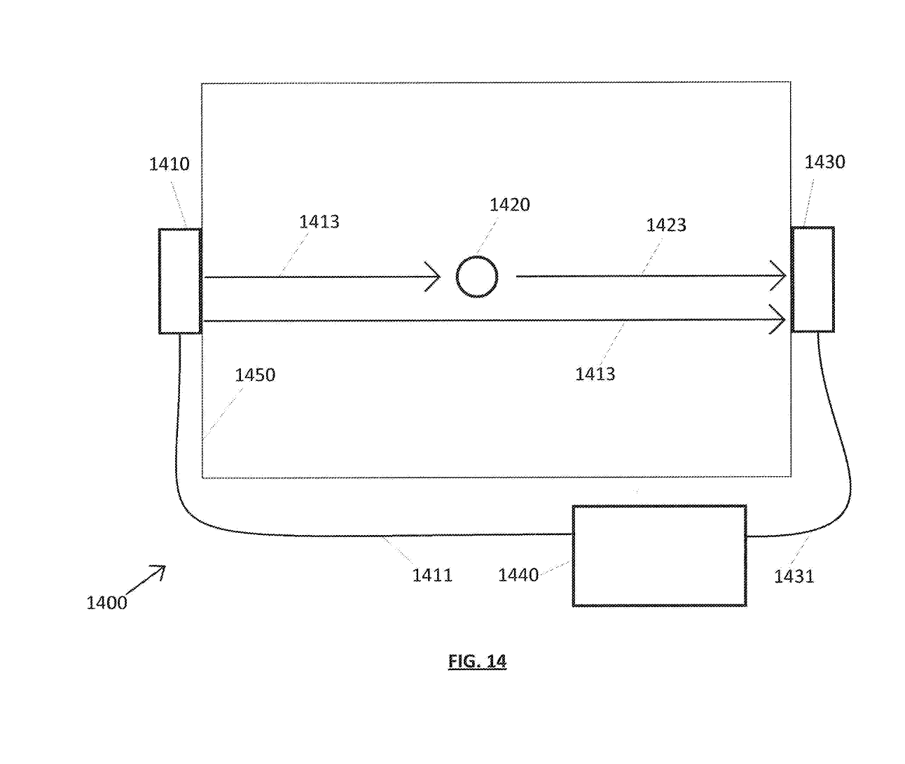

FIG. 12 shows typical power spectra of the acoustic responses as a function of both frequency and bubble production rate (BPR-Hz). The frequencies of the first harmonic (fundamental) maximum f₁ₘₐₓ 1210 and interference minimum f₁ₘᵢₙ 1220 acoustic power response are readily apparent at all bubble production rates. There is a slight downward shift in the frequency position of the first harmonic peak as bubble production rate increases. This is probably attributable to bubble group acoustic effects and can be readily taken into account for the purposes of prediction of bubble size and solids mass loading. The position of the interference minimum appears to be (relatively) unaltered by the bubble production rate. Hence the power spectrum of the total acoustic response of a stream of insonated bubbles can still be used to deduce the properties of the bubbles.

In a third series of experiments, a swarm or cloud of bubbles was generated by a bubble diffuser plate mounted near the base of a glass water tank and connected to a continuous air source. An acoustic transducer and broadband hydrophone were mounted at known separation distances and the total AE response investigated as a function of aeration rate, transducer-hydrophone separation and acoustic source characteristics. FIG. 13 shows a graph of the typical power spectra of the acoustic responses of both insonated and passively emitting bubbles. This figure clearly shows a strong total acoustic response due to the excitation beam and insonated bubble resonance. Again, there is a clear maximum frequency of total response that is due to bubble fundamental resonant excitation by the acoustic source at a frequency appropriate to the size of the bubble. There is a strong interference minimum at a slightly higher frequency. There is also a strong total acoustic response at frequencies higher than the interference minimum but this largely represents the characteristics of the excitation acoustic source. The frequencies of the extrema in the total acoustic power spectra can still be used to deduce bubble properties even in the case of a cloud or swarm of bubbles, given an appropriate acoustic excitation and monitoring configuration.

The general methodology as herein described to determine bubble properties from an acoustic response is as follows: driving an acoustic source to insonate one or more bubbles in a liquid and excite the bubble/s to oscillate in a resonant response; measuring the response signals generated by the bubble oscillation as well as the source signal using an acoustic receiver; analysing the received signal to determine the frequency locations of the extrema in the total power of the received signal associated with the fundamental resonance frequency f₁ₘₐₓ, the interference minimum f₁ₘᵢₙ and optionally the second harmonic maximum f₂ₘₐₓ; and finally, calculating/estimating the required bubble properties using the equations derived above.

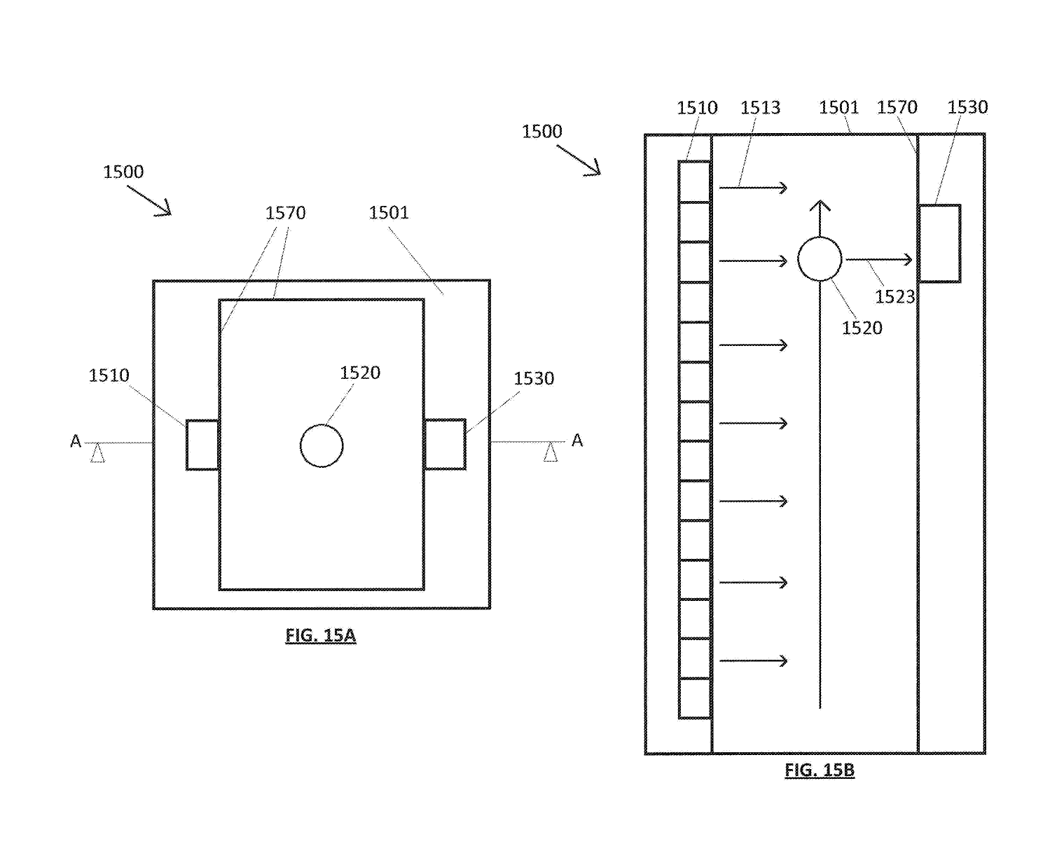

The methodology of the invention may be embodied in one of several device configurations. Firstly, and referring to FIG. 14, a schematic diagram of the acoustic spectrometer 1400 in accordance with one embodiment of the invention is illustrated. The acoustic spectrometer 1400 comprises a single source 1410 and a single receiver 1430, which are connected to control means 1440 via cables 1411 and 1431 respectively. The source 1410 and receiver 1430 have mounting means (not shown) so that they can be mounted to the internal or external walls 1450 of a vessel which contains liquid with gas bubbles 1420 to be measured.

The control means 1440 comprises electronic circuitry to provide power to the source 1410 and receiver 1430, control the signal output of the source 1410, and receive the signal detected by the receiver 1430 for analysis. The control means 1440 also comprises a computer with software for analysing the received signal, and a user interface for controlling the acoustic spectrometer 1400 and reading out measurements of the bubble properties.

The operation of the acoustic spectrometer 1400 involves an acoustic source signal 1413 being transmitted from the source 1410 towards the receiver 1430 where it is detected. A target bubble 1420, substantially aligned with and existing between the source 1410 and receiver 1430, is insonated with acoustic energy by the source signal 1413 and excited into a resonant response. Some of the acoustic energy will be retransmitted from the bubble 1420 as a response signal 1423. Both the source signal 1413 and the response signal 1423 are detected by the receiver 430 and transferred to the control means 1440 for analysis.

Another embodiment of an acoustic spectrometer as a movable device 1500 is illustrated in FIG. 15A (a top view) and FIG. 15B (a front elevation, section A-A). The acoustic source 1510, receiver 1530, and possibly also control means (not shown), are mounted in a support structure 1501, which can be moved through a liquid supporting bubbles. The spectrometer 1500 includes a plurality of acoustic sources 1510 operated coherently such that a bubble 1520 moving through the spectrometer 1500 will be insonated and excited to oscillate in a resonant response before reaching the region of the receiver 1530 based on a flow rate estimate of the residence time of a bubble within the system versus being larger than the characteristic time to achieve a steady acoustic response to source excitation for bubbles of the type expected in the application of interest. The spectrometer 1500 may include anechoic walls or boundaries 1570, at least partially surrounding the insonation volume defined as the region within which a bubble is insonated by the source sufficiently to achieve an acoustic response that is detectable above background noise at the receiver location. The control means may be included in the support structure 1501, or external to the device and connect via cables.

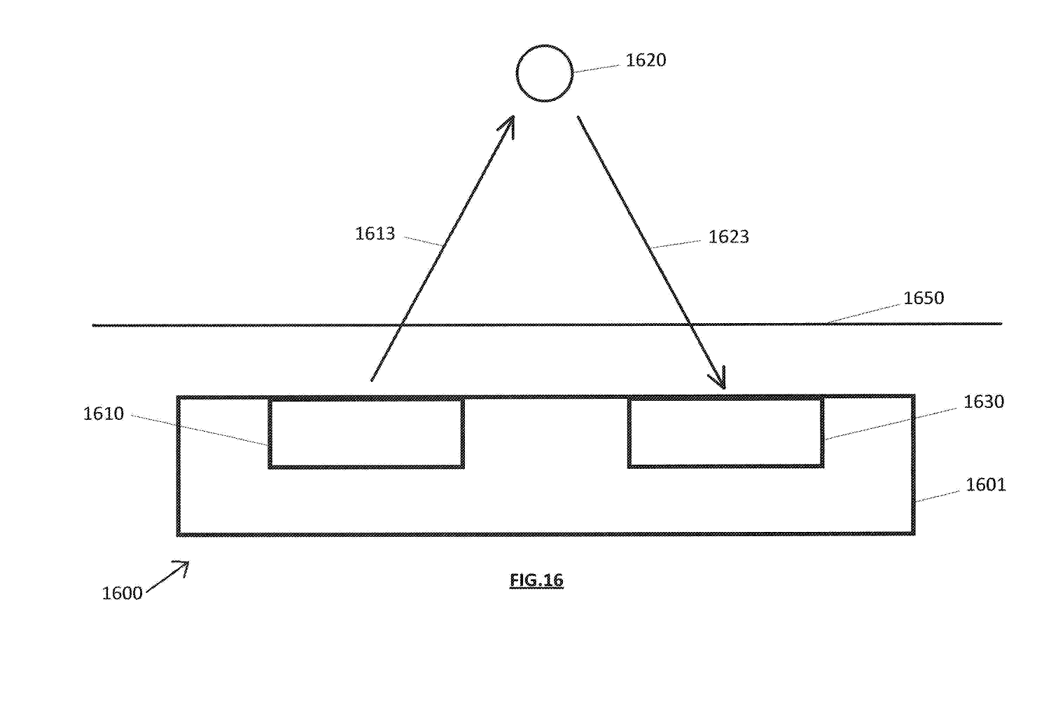

Another embodiment of the acoustic spectrometer as a movable device 1600 is illustrated schematically in FIG. 16. An acoustic source 1610 is mounted in a support structure 1601 alongside an acoustic receiver 1630. The acoustic spectrometer is movable around the outer walls of a vessel 1650 containing a liquid supporting bubbles. Control means 1640 (not shown) may be housed within the structure 1601 or connected to the device via a cable. An acoustic signal 1613 is transmitted by the source 1610 and excites a bubble 1620 into resonant oscillation. A response signal 1623 is then transmitted by the oscillating bubble 1620 and detected by the receiver 1630 for analysis. The back-scattered signal from the bubble to the position of the receiver 1630 will include both reflected (source) and resonantly excited (bubble) components. A suitable spectral analysis of these combined signals will allow detection of acoustic characteristics including bubble fundamental and second harmonic resonance responses and an interference minimum between the bubble response and reflected source beams that will permit the estimation of bubble properties.

In alternative embodiments to those described above, there may be one or more source and one or more receiver. The control means may be included in the structure of the device or may be connected to the device via cables. The control means may be connected to a separate computer for remote control and analysis. The device may be powered by a battery or an external power source. The control means for driving the acoustic source may be a separate device from the analysis unit receiving the signal from the acoustic receiver. The source, receiver and/or control means may be submergible in the liquid supporting the bubbles to be measured, or used outside of a vessel containing the liquid. The device may be scaled to different sizes for different applications. The device may be a microfluidic device. The device may comprise anechoic boundaries. The source and/or receiver may be strongly directional or transmit/detect in a range of directions. The device may be in communication with online monitoring tools, which may comprise software for signal analysis.

It should be appreciated that different sources and receivers may be selected for different applications which may involve different ranges of bubble properties in different types and amounts of liquid. A different frequency range is required for: different bubble sizes, different attached solids mass loadings and different surface layer dilatational viscosities and surface tensions. The required transmission power of the source is related to energy required to excite a resonant response in the bubble—which is dependent on the properties listed above—as well as the distances between the source, bubble and receiver, and the signal attenuation in the fluid. The source power should not be so high as to could cause transient cavitation or bubble break-up. The required sensitivity of the receiver depends on the magnitude of signals from the source and the bubble across the frequency range, as well as the distance of the receiver from the source and the bubble, and the attenuation of the signals through the liquid. The source and receiver should be selected such that their performance characteristics are suitable for the intended range of operation.

The equations derived above are used to estimate bubble properties from the acoustic response signal. The equations may also be used to estimate the required frequency range of operation for particular applications where an expected range of bubble properties is known a priori. The performance characteristics of the source and receiver should be sufficiently powerful/sensitive over at least a frequency range from below the lowest expected fundamental frequency f₁ₘₐₓ to above the highest expected second harmonic f₂ₘₐₓ. The required acoustic power of the source can be estimated by a variety of means. The theory combined with a priori knowledge of the likely range of the properties of the bubbles, attached solids and liquid medium for the situation of interest plus the geometry of the acoustic spectrometry system, the insonation characteristics (pulsed, swept frequency, white noise or other excitation) and the sensitivity of the receiver system could be used to estimate the source acoustic power necessary to ensure the fundamental resonance response maximum and the interference minimum in receiver acoustic power are clearly detectable above noise. In practice, the best approach may be using a test system for the range of bubbles likely to be encountered in the situation of interest (known bubble and attached solids mass loadings), system geometry and receiver characteristics and observing whether the power of a given acoustic source results in clearly detectable acoustic characteristics at the receiver. The degree of sensitivity required by the acoustic receiver may similarly be estimated from theory combined with a priori knowledge of the likely range of the properties of the bubbles, attached solids and liquid medium for the situation of interest plus the geometry of the acoustic spectrometry system, the power of the source transducer, the insonation characteristics and the acoustic power of the source. Again experiments with a test system similar to the situation of interest may be the best guide in choice of receiver. The source and receiver characteristics must be matched so that the acoustic receiver power response for the situation of interest is sufficiently sensitive such that it unambiguously includes a bubble fundamental resonance maximum and an interference minimum at frequencies that are resolvable by the spectrometer with sufficient accuracy to provide robust estimates of the bubble properties of interest.

The device may be used to measure various properties of gas bubbles in a liquid or adapted to measure various properties of liquid droplets in a different liquid (e.g. oil droplets in water). The liquid may contain solid particles, which may be attached to the bubbles or droplets.

It is envisaged that the field of the use of the invention is wide reaching, for example certain embodiments could be applied to (i) the monitoring of flotation separation efficiency in mineral processing (pulp bubble size, attached solids mass loading distributions, local voidage and locations), (ii) the monitoring of bubble size, attached solids mass loading distributions, local voidage and locations in bubble columns and other multiphase reactors, and (iii) the monitoring of the efficiency of microbubble water treatment (attachment of hydrophobic contaminant solids to bubble shells). Still further it is envisaged that the field of the use of the invention could extend to the monitoring of medical microbubbles/microspheres in vitro and in vivo for bubble characteristics such as equilibrium size, encapsulating elastic layer dilatational viscosity and attached solids mass loading, plus bubble location. Further potential applications include determining ultrasound contrast agent characteristics, efficiency of drug and gene therapeutic delivery (decrease in encapsulating shell solids attachment with residence time), and estimation of presence and mass concentration of chemical compounds or viral loads in liquids including serums and the blood stream (increase in encapsulating shell solids attachment with residence time for suitable analytes/receptors impregnated on the outside of the encapsulating layer).

It is envisioned that the theory will be further developed for active acoustic resonance interference spectroscopy of solids coated (and possibly elastic layer encapsulated) liquid droplets contained within another liquid. The invention could be used in conjunction with this additional theory for estimation of droplet size, attached solids mass loading and any encapsulating layer dilatational viscosity. This development might have applications in monitoring of blood cellular components, and multicomponent liquid flows in the petrochemical (oil and water mixtures) and other chemical industries (including the solvent extraction process in mineral processing).

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### LIST OF SYMBOLS USED THROUGHOUT THE SPECIFICATION

R(t) bubble wall radius at time t

R₀ bubble equilibrium radius

Rₚ radius of an individual solid particle

ε(t) thickness of the pseudo-solid layer attached to the bubble surface

ρₐₜₜ(t) density of the pseudo-solid layer attached to the bubble surface

ρₛ density of a single solid particle attached to the bubble surface

ρ_{L} density of the incompressible liquid in the interstices between particles

δₛ attached solids volume fraction

P(t) applied pressure field

P₀ ambient pressure

κ gas polytropic index

σ surface tension

μ liquid viscosity

κₛ surface dilatational viscosity of any elastic layer

χ₀ elastic compression modulus

η amplitude of the acoustic forcing of the bubble relative to the ambient background pressure

Ω angular frequency of the pressure forcing

Γₚ attached solids mass loading nonlinearity factor

Γₚ* characteristic value of the mass loading nonlinearity factor

ξ perturbation parameter

τ scaled time

ω angular frequency

Δ time and angular frequency scaling factor

ωₚ scaled angular eigenfrequency of the system

bₚ, cₚ liquid and shell viscosity damping terms

α coupling coefficient

r_{SB} distance between the source and the bubble

rₜₒₜ distance between the source and the receiver

φ phase angle of the bubble wall oscillation response with respect to the forcing excitation

C bubble radius oscillation amplitude

P̅_{ω}² source excitation frequency

P̅_{2ω}² double excitation frequency

f₁ₘᵢₙ a frequency interference minimum

f₁ₘₐₓ a bubble resonance fundamental frequency maximum

f₂ₘₐₓ a second harmonic resonance response frequency

1. An acoustical method to estimate one or more properties of bubbles in a liquid like medium, the acoustical method comprising:
acoustically exciting one or more bubbles in a liquid like medium to oscillate at a resonant frequency;
detecting a first signal emitted from an acoustical source arranged to acoustically excite the one or more bubbles and detecting a second signal produced from the one or more bubble oscillations;
deriving at least a first and a second characteristic by performing frequency domain analysis on the detected first and second signals, the first characteristic comprising a frequency interference minimum f₁ₘᵢₙ and the second characteristic comprising a bubble resonance fundamental frequency maximum f₁ₘₐₓ; and
estimating one or more bubble properties from at least the first and second characteristics.

2. The method according to claim 1, further comprising deriving a third characteristic comprising a second harmonic resonance response frequency f₂ₘₐₓ.

3. The method according to claim 1, where the step of acoustically exciting the one or more formed bubbles to oscillate at a resonant frequency comprises driving the acoustical source to generate one of a pulsed signal, a tone burst signal, a chirp signal and a broadband acoustic source signal.

4. The method according to claim 1, where the bubble property includes the bubble equilibrium radius R₀, and where R₀ and is estimated from f₁ₘₐₓ and f₁ₘᵢₙ using the relationship:
$${R}_{0} = \frac{1}{2 π} \sqrt{\frac{1}{{f}_{1 max}^{2}} - \frac{1}{{f}_{1 min}^{2}}} \sqrt{\frac{3 κ {p}_{0} + \frac{2 {σ}_{0}}{{R}_{0}} ( 3 κ - 1 ) + \frac{4 {χ}_{0}}{{R}_{0}}}{{ρ}_{L} E Θ}} ; ( {f}_{1 min} > {f}_{1 max} )$$
where Θ is a dimensionless coefficient defined by the relationship: Θ =ζΔ+\sqrt{1+ζ²Δ²}, ζ is a coefficient defined by the:
$$ϛ = \frac{1 + {λ}^{2}}{1 - {λ}^{2}} ; λ = \frac{{f}_{1 max}}{{f}_{1 min}} ,$$
E is a dimensionless coefficient defined by:
$$E = {R}_{0} ( \frac{1}{r} + \frac{1}{{r}_{SB}} ) ,$$
and Δ is a dimensionless coefficient defined by:
$$Δ = \frac{16 {( μ + \frac{{κ}_{S}}{{R}_{0}} )}^{2}}{{R}_{0}^{2} {ρ}_{L} [ 3 κ {p}_{0} + \frac{2 {σ}_{0}}{{R}_{0}} ( 3 κ - 1 ) + \frac{4 {χ}_{0}}{{R}_{0}} ] E} ,$$
where the gas polytropic index κ, ambient pressure p₀, surface tension at equilibrium bubble radius σₒ, elastic compression modulus χ₀, liquid viscosity μ, liquid density ρ_{L}, and encapsulating layer dilatational viscosity κₛ are predetermined, the distance r between the bubble and receiver and distance r_{SB} between the source and bubble are approximated, and where the bubble is either free or encapsulated.

5. The method according to claim 4, where the attached solids mass loading Mₛ is estimated from f₁ₘₐₓ and f₁ₘᵢₙ and R₀ using the relationship:
$${M}_{S} = \frac{{R}_{0}}{δ} [ \frac{3 κ {p}_{0} + \frac{2 {σ}_{0}}{{R}_{0}} ( 3 κ - 1 ) + \frac{4 {χ}_{0}}{{R}_{0}}}{4 {π}^{2} {ρ}_{L} {f}_{1 max}^{2}} - {R}_{0}^{2} + \frac{{R}_{0}^{2}}{2} E ( 1 - Θ ) ] ,$$
where the solids density coefficient δ is defined
$$δ = \frac{1}{4 π} ( \frac{1}{{ρ}_{L}} - \frac{1}{{ρ}_{S}} )$$
and σₛ is the solid density.

6. The method according to claim 4, where the attached solids mass loading Mₛ is estimated from f₁ₘₐₓ and f₁ₘᵢₙ and R₀ using the relationship:
$${M}_{S} = \frac{{R}_{0}}{δ} [ ( \frac{3 κ {p}_{0} + \frac{2 {σ}_{0}}{{R}_{0}} ( 3 κ - 1 ) + \frac{4 {χ}_{0}}{{R}_{0}}}{4 {π}^{2} {ρ}_{L}} ) ( \frac{\frac{1}{{f}_{1 max}^{2}} + \frac{1}{{f}_{1 min}^{2}}}{2} ) - {R}_{0}^{2} ( 1 - \frac{E}{2} ) ] .$$

7. The method according to claim 4, where the encapsulating layer dilatational viscosity κₛ is estimated from f₁ₘₐₓ and f₁ₘᵢₙ and R₀ using the relationship:
$${κ}_{S} = {R}_{0} \{ \frac{{R}_{0}}{4} \sqrt{( \frac{{Θ}^{2} - 1}{2 Θϛ} ) E {ρ}_{L} [ 3 κ {p}_{0} + \frac{2 {σ}_{0}}{{R}_{0}} ( 3 κ - 1 ) + \frac{4 {χ}_{0}}{{R}_{0}} ]} - μ \} ,$$
where the dimensionless coefficient Θ is expressed as:
$$Θ = [ \frac{3 κ {p}_{0} + \frac{2 {σ}_{0}}{{R}_{0}} + \frac{4 {χ}_{0}}{{R}_{0}}}{4 {π}^{2} {ρ}_{L} {ER}_{0}^{2}} ] ( \frac{1}{{f}_{1 max}^{2}} - \frac{1}{{f}_{1 min}^{2}} ) .$$

8. The method according to claim 1, where the bubble property includes the bubble equilibrium radius R₀, and R₀ is estimated from f₁ₘₐₓ using the relationship:
$${R}_{0} = \frac{1}{2 π {f}_{1 max}} \sqrt{\frac{3 κ {p}_{0} + \frac{2 {σ}_{0}}{{R}_{0}} ( 3 κ - 1 ) + \frac{4 {χ}_{0}}{{R}_{0}}}{{ρ}_{L} [ 1 - \frac{E}{2} ( 1 - Θ ) ]}} ,$$
where Θ is a dimensionless coefficient defined by the relationship: Θ=ζΔ+\sqrt{1+ζ²Δ²}, ζ is a coefficient defined by the relationship:
$$ϛ = \frac{1 + {λ}^{2}}{1 - {λ}^{2}} ; λ = \frac{{f}_{1 max}}{{f}_{1 min}} ,$$
E is a dimensionless coefficient defined by the relationship:
$$E = {R}_{0} ( \frac{1}{r} + \frac{1}{{r}_{SB}} ) ,$$
and Δ is a dimensionless coefficient defined by the relationship:
$$Δ = \frac{16 {( μ + \frac{{κ}_{S}}{{R}_{0}} )}^{2}}{{R}_{0}^{2} {ρ}_{L} [ 3 κ {p}_{0} + \frac{2 {σ}_{0}}{{R}_{0}} ( 3 κ - 1 ) + \frac{4 {χ}_{0}}{{R}_{0}} ] E} ,$$
and where the gas polytropic index κ, ambient pressure p₀, surface tension at equilibrium bubble radius σₒ, elastic compression modulus χₒ, liquid viscosity μ, liquid density σ_{L} and encapsulating layer dilatational viscosity κₛ are predetermined and the distance r between the bubble and receiver and distance r_{SB} between the source and bubble are approximated, and where the bubble is a clean unloaded bubble.

9. The method according to claim 1, where the bubble property includes the bubble equilibrium radius R₀, and R₀ is estimated from f₁ₘₐₓ and f₁ₘᵢₙ using the relationship:
$${R}_{0} = \frac{1}{2 π} \sqrt{\frac{1}{2} ( \frac{1}{{f}_{1 max}^{2}} + \frac{1}{{f}_{1 min}^{2}} )} \sqrt{\frac{3 κ {p}_{0} + \frac{2 {σ}_{0}}{{R}_{0}} ( 3 κ - 1 ) + \frac{4 {χ}_{0}}{{R}_{0}}}{{ρ}_{L} [ 1 - \frac{E}{2} ]}} ,$$
where the gas polytropic index κ, ambient pressure p₀, surface tension σₒ, elastic compression modulus χ₀, and liquid density σ_{L} are predetermined and the distance r between the bubble and receiver and distance r_{SB} between the source and bubble are approximated, and where the bubble is a clean unloaded bubble.

10. The method according to claim 1, where the encapsulating layer dilatational viscosity κₛ is estimated from f₁ₘₐₓ and f₁ₘᵢₙ and known or estimated equilibrium radius R₀ using the relationship:
$${κ}_{S} = {R}_{0} \{ \frac{{R}_{0}}{4 ϛ} \sqrt{\frac{{ρ}_{L}}{2} [ 3 κ {p}_{0} + \frac{2 {σ}_{0}}{{R}_{0}} ( 3 κ - 1 ) + \frac{4 {χ}_{0}}{{R}_{0}} ] [ \frac{{( 2 - E )}^{2} - {ϛ}^{2} {E}^{2}}{2 - E} ]} - μ \} ,$$
where the liquid viscosity μ and density σ_{L}, gas polytropic index κ and bubble surface tension parameters are predetermined, and r and r_{SB} are approximated, and where the bubble is a ‘clean’ (unloaded) bubble.

11. (canceled)

12. The method according to claim 1, where R₀ is estimated from f₁ₘₐₓ and f₁ₘᵢₙ via the relationship:
$${R}_{0} = \frac{1}{2 π {f}_{1 max}} \sqrt{\frac{3 κ {p}_{0} + \frac{2 {σ}_{0}}{{R}_{0}} ( 3 κ - 1 )}{{ρ}_{L}}} or {R}_{0} = \frac{1}{2 π {f}_{1 min}} \sqrt{\frac{3 κ {p}_{0} + \frac{2 {σ}_{0}}{{R}_{0}} ( 3 κ - 1 )}{{ρ}_{L} ( 1 - E )}} ,$$
where
$$E = 1 - {( \frac{{f}_{1 max}}{{f}_{1 min}} )}^{2} ,$$
and where the gas polytropic index κ, ambient pressure p₀, surface tension σₒ, and density σ_{L} are predetermined, and where there are nil attached solids, for a free bubble and negligible liquid viscosity effects on the bubble characteristics.

13. The method according to claim 12, wherein the attached solids mass loading Mₛ is estimated in the case of a free bubble and negligible liquid viscosity effects on the bubble characteristics using the relationship:
$${M}_{S} = \frac{{R}_{0}}{δ} ( \frac{3 κ {p}_{0} + \frac{2 {σ}_{0}}{{R}_{0}} ( 3 κ - 1 )}{4 {π}^{2} {ρ}_{L} {f}_{1 max}^{2}} - {R}_{0}^{2} ) ,$$
where
$$δ = \frac{1}{4 π} ( \frac{1}{{ρ}_{L}} - \frac{1}{{ρ}_{S}} )$$
and where σₛ, the density of a single solid particle attached to the bubble surface is predetermined.

14. The method according to claim 12, wherein Mₛ is estimated using the relationship:
$${M}_{S} = {R}_{0} \frac{[ 3 κ {p}_{0} + \frac{2 {σ}_{0}}{{R}_{0}} ( 3 κ - 1 ) ]}{4 {π}^{2} {ρ}_{L} δ} [ \frac{1}{{f}_{1 max}^{2}} - \frac{1}{E} ( \frac{1}{{f}_{1 max}^{2}} - \frac{1}{{f}_{1 min}^{2}} ) ] ,$$
where
$$δ = \frac{1}{4 π} ( \frac{1}{{ρ}_{L}} - \frac{1}{{ρ}_{S}} )$$
and where σₛ, the density of a single solid particle attached to the bubble surface is predetermined.

15-18 (canceled)

19. A device to estimate one or more properties of bubbles in a liquid or liquid like medium, the device comprising:
a chamber or vessel to contain or enable passage of a liquid or liquid like medium, the liquid or liquid like medium supporting one or more bubbles;
at least one acoustic source configured to acoustically excite the one or more bubbles to oscillate at a resonant frequency;
at least one broadband acoustic detector to detect a first signal emitted from the acoustic source and to detect a second signal produced from the bubble oscillations; and
control means to (i) derive at least a first and a second characteristic by performing frequency domain analysis on the detected first and second signals, the first characteristic comprising a frequency interference minimum f₁ₘᵢₙ and the second characteristic comprising a bubble resonance fundamental frequency maximum f₁ₘₐₓ; and (ii) estimate one or more bubble properties from at least the first and second characteristics.

20. The device according to claim 19 wherein the control means is operable to derive a third characteristic comprising a second harmonic resonance response frequency f₂ₘₐₓ

21. The device according to claim 19, wherein the control means is operable to perform frequency domain analysis on the detected first and second signals, or the first, second and third signals in order to determine the first f₁ₘᵢₙ and second characteristic f₁ₘₐₓ, or first f₁ₘᵢₙ, second fₘₐₓ, and third characteristics f₂ₘₐₓ.

22. The device according to claim 19, further comprising a plurality of acoustic sources configured to operate coherently in an array.

23. The device according to claim 19, wherein the or each acoustic source is situated either (i) on an interior wall of the chamber, (ii) on an exterior wall of the chamber or (iii) within the body of liquid containing bubbles.

24-32. (canceled)

33. An acoustical method to estimate the equilibrium size, and location of at least one unloaded bubble in a liquid-like medium, the acoustical method comprising:
acoustically exciting one or more bubbles in a liquid like medium to oscillate at a resonant frequency;
detecting a first signal emitted from an acoustic source and arranged to acoustically excite the one or more bubbles and detecting a second signal produced from the one or more bubble oscillations;
deriving at least a first, a second and a third characteristic by performing frequency domain analysis on the detected first and second signals, the first characteristic comprising a frequency interference minimum f₁ₘᵢₙ, the second characteristic comprising a bubble resonance fundamental frequency maximum f₁ₘₐₓ and the third characteristic comprising a second harmonic resonance response frequency f₂ₘₐₓ;
estimating Rₒ from each of the three characteristics based on a priori knowledge of the bubble surface dilatational viscosity, liquid viscosity (p) and the density of the liquid-like medium (ρ_{Sl}); and
estimating the location of the at least one bubble using Rₒ.

34. (canceled)

35. An acoustical method to estimate the equilibrium size, attached solids mass loading and location of at least one loaded bubble in a liquid-like medium, the acoustical method comprising:
acoustically exciting one or more bubbles in a liquid like medium to oscillate at a resonant frequency;
detecting a first signal emitted from an acoustic source and arranged to acoustically excite the one or more bubbles and detecting a second signal produced from the one or more bubble oscillations;
deriving at least a first, a second and a third characteristic by performing frequency domain analysis on the detected first and second signals, the first characteristic comprising a frequency interference minimum f₁ₘᵢₙ, the second characteristic comprising a bubble resonance fundamental frequency maximum f₁ₘₐₓ and the third characteristic comprising a second harmonic resonance response frequency f₂ₘₐₓ;
estimating Rₒ from each of the three characteristics based on a priori knowledge of the bubble surface dilatational viscosity, liquid viscosity (μ), bubble surface tension (σ)), bubble gas polytropic index (κ) and the ambient pressure of the liquid-like medium (p₀);
estimating the attached solids mass loading Mₛ using Rₒ and using Mₛto estimate the location of said one or more bubbles.
